(19) United States
(12) Patent Application Publication
(10) Pub. No.: US 2020/0380476 A1
(43) Pub. Date: Dec. 3, 2020

(54) Distributed Ledger Management System for Interest Bearing Digitized Fiat Currencies

(71) Applicant: Eris Digital Holdings, LLC, Chicago, IL (US)

(72) Inventors: Matthew Trudeau, Brooklyn, NY (US); Tony Acuna-Rohter, Des Plaines, IL (US); Anita Nikolich, Chicago, IL (US); Benedict Brady, Evanston, IL (US); Joseph McGlawn, Brooklyn, NY (US)

(21) Appl. No.: 16/889,664

(22) Filed: Jun. 1, 2020

Related U.S. Application Data
(60) Provisional application No. 62/854,960, filed on May 30, 2019.
(60) Provisional application No. 62/930,379, filed on Nov. 4, 2019.

(51) Int. Cl. G06Q 20/06; G06Q 20/38; G06Q 40/02

(52) U.S. Cl. CPC G06Q 20/0655; G06Q 40/02; G06Q 20/389

(57) ABSTRACT

A blockchain-based, distributed ledger management system for interest bearing digital coins is provided. In the blockchain-based, distributed ledger management system, a custodial bank receives an electronic deposit of fiat currency from a customer that is entitled to periodic payment of interest. In response, a fiat coin issuer system activates a blockchain-based smart contract that creates fiat coin in proportion to the dollar value of the fiat currency. The fiat coin is then distributed to the public address of the customer on the blockchain. Later, when interest is due to be paid on the deposit of fiat currency, a blockchain node system executes a smart contract that calculates the interest amount due and generates additional fiat coin in proportion to the dollar value of the interest. The additional fiat coin is then distributed to the public address of the customer on the blockchain.

### CROSS-REFERENCE TO RELATED APPLICATIONS

The present application claims the benefit of U.S. Provisional Application No. 62/854,950, filed May 30, 2019, entitled “DISTRIBUTED LEDGER MANAGEMENT SYSTEM FOR INTEREST BEARING DIGITIZED FIAT CURRENCIES”, and U.S. Provisional Application No. 62/930,379, filed Nov. 4, 2019, entitled “DISTRIBUTED LEDGER MANAGEMENT SYSTEM FOR INTEREST BEARING DIGITIZED FIAT CURRENCIES”, both which are hereby incorporated by reference in their entirety.

### BACKGROUND OF THE INVENTION

The present invention generally relates to a blockchain-based distributed ledger management system. More particularly, the present invention relates to a blockchain-based distributed ledger management system based on a fiat currency.

As Internet-commerce has grown, digital assets have proliferated. A digital asset is a physical or other asset which may be represented digitally, with scarcity controls embedded in its design. The concept of “digital scarcity” is an important improvement. Previously digital “objects” such as computer files (for example a digital photograph or document) could be copied infinitely. Digital Rights Management (DRM) tools were invented as a system to prevent copyrighted content from being pirated or otherwise copied and redistributed in violation of copyright. Digital assets are desirable because they are easy to create, cannot be copied, are easy-to-transact in digital commerce, have low barriers to entry, and have relatively few technical restrictions on transfer and use (legal and regulatory restrictions may apply on a case-by-case basis).

Many digital assets are blockchain based, meaning they are “native” to the blockchain, i.e. embedded in their fundamental protocol, and digital assets that exist independently may be “attached” to blockchains, e.g. a physical object such as gold that is digitally represented on a blockchain. A blockchain is a distributed ledger that tracks the balances of digital assets in various accounts.

Distributed ledgers may be either public or private. A private distributed ledger has all transactions validated by designated network participants who typically know and trust each other, and access to the network may be controlled by a central trusted party or parties. A public distributed ledger is one in which there are no restrictions on who may join the network and validate transactions, and which generally has no single person or entity in charge. Transaction validators on public ledgers are often known as miners, and compete with one another to validate transactions in return for some form of compensation.

An example of a public distributed ledger is the Bitcoin blockchain. Bitcoin is a cryptocurrency digital asset that is natively issued on the Bitcoin blockchain. Another example is the Ethereum blockchain and its native cryptocurrency ether.

To use a blockchain based digital asset, a user runs software called a client designed to interface and interact with a desired blockchain. The client verifies the correct state of the blockchain and permits the user to send or receive digital assets. Users of the Ethereum network may also create and/or interact with smart contracts that enable the execution of arbitrary code and may support a wide range of “on-chain” applications that include instructions for computation on the Ethereum blockchain.

Using smart contracts, the Ethereum network also permits the creation of new digital assets, including non-native assets, typically in accordance with a pre-defined standard such as ERC-20 or ERC-721. These assets are governed by smart contracts and, as permitted by the contract, may be freely transferred or transferred according to specific constraints such as white or black listing, between accounts and other smart contracts on the Ethereum network, and may be used to access the functionality of the assets' own or other smart contracts.

Some digital assets, such as Bitcoin, Ether, and other Ethereum-based assets, are created and distributed according to a pre-programmed distribution schedule or formula. The distribution methodology may be encoded in the foundational protocol of the blockchain (such as Bitcoin or Ethereum), managed by the creator of the digital asset, or encoded within the smart contract programmed to issue the digital asset. Many new digital assets, including cryptocurrencies, have been launched since the launch of Bitcoin and Ethereum. Some of them are launched using new consensus and security/privacy mechanisms and some have been merely copies of existing protocols. Sometimes, in an effort to make a new protocol, digital asset, or cryptocurrency relevant, reserves of the new asset are issued to owners of existing digital assets, such as bitcoin. There are a variety of mechanisms through which this may be carried out. A common approach is known as an “airdrop”. In this approach, for example, every owner of a bitcoin might receive one (or more) of the new digital assets in their public address.

Digital assets trade on various electronic exchanges (centralized and decentralized) and their prices may be quite volatile. Accordingly, there has been a heavy interest in the creation of digital assets that may offer similar utility with less volatility, especially digital assets that represent currencies such as gold, and fiat currencies. As used herein, “fiat currency” refers to traditional currencies, such as the US Dollar, Euro, or Yen, that are issued by a central bank of a government and are declared (by fiat of the issuing government) to be legal tender, even though they are not backed by any underlying physical commodity, such as gold. Native digital assets, such as ether or bitcoin, are not linked to physical reserves or any other property off-chain, and they are distinguished from “fiat currencies” because there is no central issuing authority with such authority that, as yet, has declared them to be legal-tender.

Creating a “digitized” fiat currency offers some of the benefits of current digital assets, with the price stability and utility of traditional fiat currencies. For that reason, various parties and governments have started researching systems to create digitized fiat currency on blockchains. For example, the Monetary Authority of Singapore has announced a project to place a tokenized form of the Singapore Dollar on a distributed ledger platform. (See http://www.mas.gov.sg/News-and-Publications/Media-Releases/2017/MAS-working-with-industry-to-apply-Distributed-Ledger-Technology.aspx). Similarly, the European Central Bank has discussed ways of issuing digitized fiat currency. (See https://www.ecb.europa.eu/press/key/date/2017/html/sp170116.en.html) Further, a private project called CENTRE has created a coin meant to be pegged to the U.S. dollar. (See https://www.centre.io/usdc).

### BRIEF SUMMARY OF THE INVENTION

Each of the approaches identified above has aimed to enable digitized fiat currency as a substitute for traditional cash. There remains a need for digitized fiat currencies with beneficial properties that go beyond being a substitute for traditional cash.

Thus, one or more of the embodiments of the present invention provide a blockchain-based, distributed ledger management system for interest bearing digital coins. In operation, a custodial bank receives an electronic deposit of fiat currency from a customer that is entitled to periodic payment of interest. In response, a fiat coin issuer system activates a blockchain-based smart contract that creates fiat coin in proportion to the dollar value of the fiat currency. The fiat coin is then distributed to the public address of the customer on the blockchain. Later, when interest is due to be paid on the deposit of fiat currency, a blockchain node system executes a smart contract that calculates the interest amount due and generates additional fiat coin in proportion to the dollar value of the interest. The additional fiat coin is then distributed to the public address of the customer on the blockchain.

In another embodiment, instead of generating additional fiat coin in response to said interest, said smart contract alters the redemption value of the fiat coin relative to the dollar value of said fiat currency to reflect the value of the interest payment.

### BRIEF DESCRIPTION OF THE DRAWINGS

FIG. 1 illustrates an embodiment of the Fiat Coin generation process according to an embodiment of the distributed ledger management system.

FIG. 2 illustrates an embodiment of the Fiat Currency and Fiat Coin Reconciliation process according to an embodiment of the distributed ledger management system.

FIG. 3 illustrates an embodiment of the Interest Election process according to an embodiment of the distributed ledger management system.

FIG. 4 illustrates an embodiment of the interest calculation and payment process according to an embodiment of the distributed ledger management system.

FIG. 5 illustrates an embodiment of the Tax Calculation, Recording and Reporting process according to an embodiment of the distributed ledger management system.

FIG. 6 illustrates an embodiment of the Fiat Coin Redemption to a Customer Address process according to an embodiment of the distributed ledger management system.

FIG. 7 illustrates an embodiment of the Fiat Coin Redemption to an Issuer Address process according to an embodiment of the distributed ledger management system.

FIG. 8 illustrates an embodiment of the Fiat Coin Application Layer according to an embodiment of the distributed ledger management system.

FIG. 9 illustrates an embodiment of the Fiat Coin Hardware Layer according to an embodiment of the distributed ledger management system.

FIG. 10 illustrates an example of the calculation and allocation of interest for multiple accounts over period p having intervals i.

FIG. 11 illustrates an embodiment of a Fiat Coin data structure in accordance with the present invention.

### DETAILED DESCRIPTION OF THE INVENTION

One or more embodiments of the present invention provide a system and method of electronically establishing and electronically controlling the payment of interest on a digitized fiat currency. By providing a computerized electronic system that allows owners of digitized fiat currency to receive interest, one or more embodiments of the present invention make digitized fiat currency more attractive to all users, and especially to institutional users.

As is further described below, in one example, electronic control of interest payment may be accomplished using a digital currency distribution. In another example, electronic control of interest payment may be accomplished by electronically adjusting the value of the ratio between the digitized fiat currency coin and the underlying fiat currency.

In an example, an issuer issues interest-bearing digitized fiat currency coins (hereafter referred to as “coins”) on a blockchain. The issuer may be a central bank, or the issuer may be a private trusted party, such as an exchange, clearinghouse or commercial bank. The blockchain on which the coins are issued may either be private or public. A user that wishes to convert fiat currency to digital currency deposits (by using e.g. wire or ACH) fiat currency funds into an account associated with the issuer. In the case of a clearing house or exchange, the account may be a custodial account in the name of the issuer, at a custodian bank. The issuer then credits the user with the proper number of coins based on the fiat currency funds deposited by activating the coin smart contract to electronically establish new coins and updating the blockchain to reflect the new coins held by the appropriate blockchain account(s).

The issuer may direct the custodian to convert the custodial account balances into pre-approved, low-risk interest-bearing instruments such as repurchase agreement contracts, money funds, or directly in government securities associated with the fiat currency (e.g. Treasurys). The custodian may engage an auditor to periodically publish the audited balance of the custodial account so that owners of the fiat coins may validate that the amount of value in the custodian account is greater than or equal to the value of all outstanding coins on the blockchain.

The custodial balances, so converted, may earn interest and the fiat coin issuer may agree to periodically pay interest to the coin owners. The interest rate may be determined by the issuer in relation to the rate earned on the deposits, and might be the rate earned from the deposits minus a fee charged by the issuer. An electronic payment system may then credit the interest to coin owners using a distribution. In a distribution, new coins are electronically established and distributed to the owners. These distributions may take place at the end of predetermined periods e.g. every business day, weekly, monthly, or even every minute.

In another implementation, there may be multiple issuers of the same digital fiat coins. In this case, any approved entity may accept fiat currency in their accounts, and may be authorized to issue additional coins, once the receipt of the digital currency had received sufficient verification. In this approach, the conversion of the fiat currency may be centrally managed, or may be separately managed by each approved entity. In this multi-issuer, separately managed approach, each issuer may be responsible for the additional liability created from each distribution. If a private ledger were used to track the digital coins, each issuer may also be responsible for transaction verification on the network. In this implementation, this initial issuer may create a vetting and approval process to accept additional approved issuers.

In another example, the coins are electronically established by a coin smart contract on a blockchain with smart contract functionality, such as Ethereum. The issuer may deploy the coin smart contract to the Ethereum network, and then owners may acquire the coins via execution of the coin smart contract. The coin smart contract may also include functionality to permit an owner to surrender coins in order to receive the underlying fiat currency funds. This may become especially useful if a central bank issued digitized fiat currency.

The coin smart contract may include computerized functions to permit control by the issuer after the contract is placed on the blockchain. A computerized function in a smart contract is a contained subroutine that may be invoked by the issuer or the owners to accomplish its predetermined functionality. In some examples, the issuer may interact with the coin smart contract by calling functions of the coin smart contract to make changes to the ownership of the coins held by various owners.

The issuer (or issuers) may have a private key that permits the issuer to sign requests to update ownership of the coins. The smart contract may ignore all requests to update ownership unless they come from the current owner of the coin or from the issuer including a signed message using the private key.

Another way of paying interest on digital fiat currency is to adjust the value of the ratio between the digitized fiat currency coin and the underlying fiat currency on a periodic basis. For example, an owner that wishes to purchase coins at a given point in time transfers fiat currency funds into a custodial account held by a custodian (such as the issuer or a third-party). The issuer then credits the owner with the proper number of coins corresponding to the transferred fiat currency funds at a current conversion ratio between the fiat currency and the coin. Periodically, the coin smart contract may determine an interest rate to be paid to all owners. The coin smart contract may then adjust the current conversion ratio to equal the previous conversion rate plus/minus an additional amount representing the interest. If interest were paid at the end of every business day, then the peg may increase (assuming positive interest rates) very slightly from one business day to the next, based on the interest rate paid.

In some examples, the roles of the issuer and the custodian may be delegated to smart contracts. For example, the issuer may have one smart contract, and the custodian may have another smart contract. More particularly, a coin smart contract that issues a coin may interact with a custodian smart contract that fills the role of the custodian. The custodian smart contract may act as an oracle for the coin smart contract (an oracle is a smart contract that collects data from external sources and places it on the blockchain for other smart contracts to use) to provide the coin smart contract with custodian information, such as: the deposit of fiat currency funds, the withdrawal of fiat currency funds, the accounting of the instrument of fiat currency funds, the accounting of any interest owed, etc.

The custodian smart contract may publish the current balance of the funds in the custodial accounts to the blockchain. The issuer contract may then distribute interest based on the published balance. For example, the issuer contract may determine the difference between the current balance of the custodial account and the balance in a previous period. The issuer contract may then generate new coins, or adjust the fiat currency/fiat coin ratio in proportion to the calculated difference and distribute the coins or update the recorded ratio, as appropriate.

The coin smart contract may make periodic checks to ensure that the number of coins held by all owners is less than or equal to the amount of fiat currency funds held in the custodial account by the custodian smart contract.

Owners who may like to redeem their digital fiat coins for traditional US Dollars are able to at any time request a transfer into their bank accounts from the coin issuer. This transfer may be made once the owner had transmitted their coins to the issuer, or burned them, where burning them is sending them to an address where they become permanently immobilized and/or the coins become otherwise destroyed. The issuer may in this case direct the custody bank to initiate a transfer to a traditional bank account designated by the owner.

The custodial account may routinely receive interest from instruments in the account. The custodian may send an accounting of the interest received to the issuer of the coin. The issuer may determine an interest rate to be paid on coins on a public or private blockchain or smart contract. The interest rate may then be communicated as an instruction to the blockchain or smart contract to credit each owner's account the appropriate amount of coins, or to make the appropriate adjustment to the conversion ratio.

Both mechanisms for interest adjustments for fiat coin owners—new fiat coin issuance and fiat currency/fiat coin ratio adjustment—must account for the possibility of a negative interest rate environment. For example, if deposits held at a custodian are subject to negative interest rates, i.e. they are charged a fee for the held deposits rather than earning interest income, then the total holdings of fiat currency will be reduced requiring a corresponding reduction in the outstanding fiat coin volume/value. This reduction may be managed by either reducing the total count of fiat coins outstanding, e.g. by a forced burn function triggered within the fiat coin smart contract by the Issuer, or by an adjustment to the conversion ratio to increase the number of fiat coins required to tender in exchange for a unit of the underlying fiat currency.

One embodiment of the present invention includes a system and method for issuing and managing fiat-backed, interest-earning digital coins, called Fiat Coin, that may be created with, and redeemed for, US dollars (or other government issued currency) held in, for example, a segregated commercial bank account, and used for settling various on-chain and off-chain digital transactions.

Customers have the ability to deposit fiat currency into a clearinghouse or other approved depository/custodial account (deposit account). Balances in the deposit account are used in transactions entered into by the custodian such as, but not limited to, repurchase agreements (repos) or to purchase securities such as money fund(s) that generate interest. Interest generated by balances so held and used in such transactions is shared with Fiat Coin owners.

Fiat Coins are created on public blockchains in, for example, 1:1 proportion to the fiat balances held in the deposit account. The fiat coins may be held in an omnibus public address on the blockchain, with accounting managed off-chain, or distributed to the public address(es) of fiat owners proportionate to their fiat deposits in the deposit account.

Owners of Fiat Coins have the ability to hold their Coins in their public address(es), transfer them to other public address(es) to transfer value, and use them to settle digital transactions via on-chain delivery versus payment (DvP).

Broadly, a Fiat Stable coin is a US Dollar (or other fiat) backed crypto asset that is exchangeable over a blockchain. Fiat Stable coins may be issued by any financial institution, or business partnering with a financial institution, where fiat currency may be safely custodied and accounted for. Fiat Stable coins issued to customers and/or acquired/owned on blockchains may be redeemed for fiat currencies from the issuer/issuing financial institution within a predefined settlement period. However, this Fiat Coin design differs in two important ways from existing Fiat Stable coins.

Interest Calculation Systems

Unlike existing Fiat Stable Coins, Fiat Coins enable owners to earn interest on their underlying fiat deposits while benefiting from the utility of the Fiat Coin for transaction purposes. The calculation and distribution of the earned interest may be managed off-chain in traditional database systems, or via a system of smart contracts on-chain. Either approach calculates and distributes interest payments in accordance with predetermined interest calculation methodologies that take into account the payment intervals of interest on underlying fiat balances, and the relevant holding period and proportion of the Fiat Coin(s). While the specific interest methodology is at the discretion of the Fiat Coin issuer, an example is to calculate and distribute interest on a monthly basis to align with the interest payment of e.g. a money fund that pays interest monthly.

Alternatively, interest may be calculated and distributed daily to align with the interest payment of e.g. an overnight repurchase agreement (repo) transaction. Yet another alternative is to calculate and distribute interest in even shorter intervals, minutes or seconds for example, in an instance where the interest is paid on such shorter intervals, potentially in the case of e.g. a fully on-chain interest earning transaction such as an on-chain repo or other asset-backed loan. The timing of the predetermined interest payments in the design is arbitrary and may be mapped to any conceivable interval of interest payments on the underlying fiat transaction.

Additionally, interest may be earned, and paid, in currenc(ies) other than the underlying fiat balances, e.g. if the fiat balances are in USD the interest may be earned/paid in CAD, JPY, EUR, GBP, BTC, ETH, etc. This conversion is facilitated using an automated market spot transaction through the fiat bank account institution or the exchange marketplace in the case of digital assets. Distribution follows the process previously described to an account with the exchange or pre-defined addresses designated on the platform. So then, generally, the Fiat Coin may represent any underlying fiat currency, any interest bearing transaction entered into with the underlying fiat currency, and the earned interest may take the form of any currency whether fiat or crypto.

Preferably, the interest earned on the underlying fiat deposits used in the (e.g. money fund or repo) transaction is distributed according to a predetermined methodology, e.g. time-based pro rata where interest is distributed in proportion to the time, of the total calculated time period, that an owner held Fiat Coin(s) on or off chain. The total amount of interest, once calculated, is then distributed to the Fiat Coin owners in the appropriate proportion. Distribution may occur off-chain where the interest is calculated by the Fiat Coin issuer and distributed to the Fiat Coin owner in a books and records system managed by the Fiat Coin issuer. Distribution may alternatively occur on-chain where a smart contract calculates and distributes interest, based on off-chain inputs from the Fiat Coin issuer, to the Fiat Coin owners' public blockchain address(es).

In some embodiments, coin holders may elect to earn a share of interest by storing their coins in designated types of wallets or sending them to a designated smart contract. The user interface design may enable coin holders to opt in and out of automatically activating interest earning mechanisms, where such automation mechanisms are employed in the design, as opposed to requiring manual interventions.

In some embodiments, positive interest is distributed in the form of newly minted coins to reflect the increase in assets, i.e. interest payable to coin holders. In opt-in interest mechanism embodiments, interest distribution is a function of a coin holder's proportionate share of the overall interest income calculated for the overall opted-in coin holders' coins, for the opted-in period. In such embodiments a system records opted-in balances in a database and, through execution of a smart contract or similar system, calculates and distributes the interest owed in the form of newly minted coins.

In one or more aspects of interest generation, a system may calculate and deduct a fee from the interest income prior to the minting and distribution of new coins to the opted-in coin holders. Such calculation and deduction is administered through the interest calculation and distribution method.

In an embodiment where interest rates are positive and new coins are minted for coins that have been opted-in to earn interest, the system calculates and mints new coins only after the fiat interest has been paid and settled (e.g. deposited) into the fiat currency account, such that the fiat currency balances are always sufficient to cover the outstanding fiat coin at a redemption rate of 1:1. Newly minted coins to reflect a settled fiat currency interest payment are only distributed to Fiat Coin owners that have opted-in, to addresses in designated opt-in eligible wallets in one embodiment, or per balances sent to a smart contract in another embodiment, over the interval of time whereby interest was accrued until subsequent fiat interest payment. This ensures coin holders that were opted in during an interval where interest was accrued but not yet paid receive distributions following settlement of the fiat currency.

The specific mechanism for distributing earned interest is also at the discretion of the Fiat Coin issuer. In one embodiment, new Fiat Coin(s) may be generated in proportion to the underlying fiat interest in accordance with the fiat currency: Fiat Coin ratio (e.g. 1:1), with newly minted Fiat Coins distributed to the public address(es) of the Fiat Coin owners, or to the public omnibus address of the Fiat Coin issuer. In another instance, the ratio of fiat to Fiat Coin may be adjusted such that each Fiat Coin represents a larger value of underlying fiat in proportion to the interest earned.

Fiat Coin to USD ratio=1:1

Interest earned=1%

New Fiat Coin to USD ratio=1:1.01

In another embodiment, the system may account for the impact of negative interest rates. Conversion rates in a negative interest environment become a function of total fiat currency deposits and investments plus negative accrued interest. Because some instruments settle interest on a deferred basis, the system must account for accrued interest to be deducted from fiat currency balances in order to not make more funds available to the coin holders, who wish to tender their Fiat Coins in exchange for fiat currency, than what would ultimately be available once interest is settled. For example, consider 100,000 Fiat Coins are created from a $100,000 deposit. With negative interest, $100 is due to be paid to the bank resulting in total assets of only $99,900. Therefore, the coins are only redeemable at a rate of 1 Fiat Coin to 0.9990 fiat currency.

In another embodiment in the negative interest rate environment, creating additional coins for conversion is done at the inverse rate of redemption. The system calculates the fiat balances, Fiat Coin outstanding, and calculates the conversion rate to determine the appropriate number of new Fiat Coin that are minted following a new deposit of fiat currency and request for conversion. This system calculation ensures new conversions are not immediately diluted in the overall coin supply.

For example consider 100,000 Fiat Coins are in circulation and backed by a fiat currency balance of $99,900. A customer wishes to convert $50,000 fiat currency into Fiat Coin. In order to maintain a redemption rate of 0.9990 at the moment of issuance, i.e. to ensure that the new Fiat Coins are not immediately worth less in fiat currency at the moment of their creation and before their underlying fiat currency balance deposited to create them has accrued any negative interest, the system calculates and mints 50,050.05 Fiat Coins. This conversion, in this example, is calculated at the rate of 1.001001 Fiat Coin to fiat currency, the inverse of 1/0.9990. With a new total funds available balance of $149,900 and Fiat Coin supply of 150,050.05, the redemption rate for all outstanding Fiat Coins to fiat currency is maintained at 0.9990.

In another embodiment, interest rates change from negative back to positive. In order to determine the redemption rate, as previously described the system determines the amount of available funds as on assets on deposit plus accrued interest. Carrying on from the example above, accrued interest changed from $100 due to be paid to the bank to $50 due to be paid from the bank, a $150 total interest change. Total assets on deposit are then $150,000 with $50 of accrued interest to be paid at a later date and a Fiat Coin supply of 150,050.05. This means coin holders may redeem at a rate of 0.999666, total available assets divided by total outstanding Fiat Coin supply, and new coins may be minted at 1.000334, the inverse of the redemption rate.

Taxes Calculation Systems

In the case of both a new coin issuance and a ratio adjustment, there may be tax implications that need to be accounted for. In the case of new coin issuance the taxes may be accounted for as capital gains on the value of the dollar interest at the time the dollar interest is earned/paid. However, there may be further tax implications to consider if the fiat coins trade a basis +/− to the underlying fiat currencies as well. For example, if the Fiat Coin to USD ratio is 1:1, but the USD/Fiat Coin trading pair prices the Fiat Coin at a premium/discount to the USD, a profit or loss may be realized when the Fiat Coin is converted into a USD equivalent as part of a transaction. In the case of a ratio adjustment, the accounting for the taxes may be more complicated and may potentially need to be deferred until the fiat coins are converted into a USD equivalent as part of a transaction. To properly account for any gains, cost basis is tracked, and calculations take into consideration e.g. the cost basis and the accounting method e.g. first-in-first-out (FIFO), last-in-first-out (LIFO). The methodology and calculation, tracking, and reporting for tax purposes are part of the service offered by the Fiat Coin issuer using an additional embodiment of the invention whereby the calculations, tracking, and reporting are managed via a smart contract and other related systems.

Whitelist System

Unlike existing Fiat Stable coins, Fiat Coins have the capability to restrict the transfer and ownership of Fiat Coins to a set of pre-approved public blockchain addresses, the “whitelist”. This whitelist functionality may be enforced on-chain through the smart contract where the smart contract references a list of authorized accounts maintained in an on-chain record, or by querying the Fiat Coin issuer off-chain and requesting a list of whitelisted addresses and/or requesting validation of a specific address. In either instance the smart contract is able to confirm whether a public address is on the whitelist. If the address is included on the whitelist the transaction may be completed. If the address is not on the whitelist the transaction is rejected.

While previous whitelist queries ensure that Fiat Coins may never be transferred to an unauthorized address (i.e. one not included on the whitelist), it is possible that, for example, a transaction could have been made in error, or an address that was previously on the whitelist was subsequently removed from the whitelist. As such, as part of the whitelist address validation, the smart contract may verify both the sending and receiving addresses to ensure they are both whitelisted addresses. If either address is not on the whitelist the transaction is rejected. In an embodiment where Fiat Coins are permitted to be transferred to and from addresses that are not on the whitelist, an alternative embodiment requires that interest is paid/accrued only to Fiat Coins held by whitelisted addresses.

In some embodiments, where there are tax or regulatory requirements tied to e.g. the identity and/or jurisdiction of residency or citizenship of an address owner, the owner may be required to prove their citizenship and/or residency.

Audit System

Many of the fiat-backed stablecoins have established the practice of publishing an Independent Accountants' Report. Thus far all reports are only published on a monthly basis. The reports generally contain an affirmation from an independent third party accounting firm that the contents of the management report have been fairly stated by the stablecoin firm's management. The management report states the amount of funds held in bank accounts along with the amount of coins/tokens in circulation. Given most stablecoins have detailed a strict 1:1 peg the notion is that these two should always be the same at the time of attestation. Some reports specify the name of the bank(s) along with funds they may be invested in (e.g. Gemini dollar https://gemini.com/dollar/#reports) while others go into greater details to describe the nature of their escrow accounts (e.g. TrueUSD https://blog.trusttoken.com/june302019-db0ea4de7022).

While the initial Fiat Coin embodiment contemplates functionality currently available and deployed on public blockchains, the technology is evolving quickly and it is anticipated that new developments in software, hardware, operational techniques, and cryptography will influence and expand the design space for Fiat Coins.

Private Transactions Systems

Currently, many of the smart contracts deployed on public blockchains have been deployed on Ethereum, making use of the Ethereum protocol and the Ethereum Virtual Machine (EVM), a system that does not presently support private transactions. As currently implemented, the Ethereum blockchain, including all transactions (for the entire history of the Ethereum blockchain), and all public address balances, is fully visible pseudonymously to the entire network. Access to the network, and hence the ability to view all transactions and balances, is available to any node operator, or user of tools and interfaces provided by node operators such as “wallet” applications and blockchain application programming interfaces (APIs).

Advances in cryptography including, for example, zk-Snarks, are expected to enable fully private blockchain transactions. Examples of support for private blockchain transactions currently include, for example, Zcash, a cryptocurrency that runs on its own blockchain, and Aztec, a zero-knowledge privacy protocol deployed on the Ethereum mainnet. Privacy protocols such as Aztec and Zcash generally support features such as e.g. a “viewing key” that enable the participants to a transaction, or other relevant parties e.g. auditors or regulators, to view the underlying details.

The Fiat Coin design anticipates the widespread adoption of such privacy technologies and techniques. In one embodiment, the system is designed such that only the Fiat Coin smart contract may query the distribution eligible account balances. Using technologies such as zk-Snarks, the transactions may be shielded, but they will be verifiably computed correctly. As introduced by Zcash, the system has the option to issue a selective disclosure, or “view” key to any and all federal agencies that need to verify the state of the assets and the transaction history on the blockchain. Combining the private information on the blockchain with the offline database linking the AML/KYC information to specific addresses allows for auditability and compliance, and verification of the enforcement of whitelists, without having to trust the Fiat Coin issuer and simultaneously protecting the privacy of the balances and transactions of Fiat Coin owners.

Smart Contract Creation and Deployment System

Fiat Coin Creation Smart Contract

In one embodiment, a Fiat Coin Creation Smart Contract is established. The Fiat Coin Creation Smart Contract creates and deploys a smart contract that creates Fiat Coins on a blockchain. The Fiat Coin Creation Smart Contract is developed by a programmer skilled in the art and written in a programming language supported by the blockchain platform upon which the smart contract is to be deployed (e.g. Solidity for Ethereum). (See https://github.com/ethereum/wiki/wiki/Ethereum-Development-Tutorial and See https://github.com/ethereum/solidity). In operation, the Fiat Coin Creation Smart Contract is compiled into and executable format according to the blockchain platform (e.g EVM bytecode for Ethereum) and is processed according to the blockchain platform (e.g. the Ethereum Virtual Machine, or EVM). (See https://github.com/ethereum/wiki/wiki/Ethereum-Virtual-Machine-(EVM)-Awesome-List)

The Fiat Coin Creation Smart Contract is deployed to a blockchain in accordance with standard deployment methodology for the blockchain upon which the smart contract is to be deployed (e.g. a Contract Account on Ethereum). (See http://ethdocs.org/en/latest/contracts-and-transactions/acces sing-contracts-and-transactions.html)

The Fiat Coin Creation Smart Contract includes programming instructions to include standard Fiat Token features and functionality such as those described in the CENTRE token design open source project. (See https://github.com/centrehq/centre-tokens/blob/master/doc/tokendesign.md) The programming instructions provide the functionality of: Minting, Burning, Blacklisting/Whitelisting, Pausing/Unpausing, Upgrading, and Role Definition and Assignment/Reassignment

The Fiat Coin Creation Smart Contract is executed by Smart Contract computation to process instructions in accordance with blockchain Smart Contract methodology (based on e.g. token standards such as ERC-20, ERC-721, etc.). (See https://github.com/ethereum/EIPs/blob/master/EIPS/eip-20.md and https://github.com/ethereum/EIPs/blob/master/EIPS/eip-721.md).

The number of Fiat Coins to generate may be based on a Fiat Coin generation ratio. In a first embodiment, the number of Fiat Coins is equal to the number of units of deposited fiat currency in a 1:1 ratio. This may represent a positive interest rate environment. In a second embodiment, the number of Fiat Coins is equal to the number of units of deposited fiat currency multiplied by the inverse of the ratio of issued Fiat Coin to fiat currency balances. In this embodiment, the number of newly minted Fiat Coins reflects the value of the deposited fiat currency. This may represent a negative interest rate environment where deposited fiat currency does not yet have negative interest accrued.

The smart contact may also determine the type of Fiat Coins to generate (e.g. ERC-20 USD-backed coin) and whether the transaction is appropriately signed.

The smart contact may also transmit Fiat Coins that have been generated to recipient public addresses.

Fiat Coin Interest Calculation and Payment Smart Contract

In one embodiment, a Fiat Coin Interest Calculation and Payment Smart Contract is established. The Fiat Coin Interest Calculation and Payment Smart Contract creates and deploys a smart contract that calculates interest owed/earned and distributes it in the form of newly minted Fiat Coins.

The Fiat Coin Interest Calculation and Payment Smart Contract is developed by a programmer skilled in the art and written in a programming language supported by the blockchain platform upon which the smart contract is to be deployed (e.g. Solidity for Ethereum). In operation, the Fiat Coin Interest Calculation and Payment Smart Contract is compiled into and executable format according to the blockchain platform (e.g EVM bytecode for Ethereum) and is processed according to the blockchain platform (e.g. the Ethereum Virtual Machine, or EVM).

The Fiat Coin Interest Calculation and Payment Smart Contract is deployed to a blockchain in accordance with standard deployment methodology for the blockchain upon which the smart contract is to be deployed (e.g. a Contract Account on Ethereum).

The Fiat Coin Interest Calculation and Payment Smart Contract includes programming instructions to include received aggregate interest payment from source (e.g. Issuer) as input. For example, the Fiat Coin Interest Calculation and Payment Smart Contract may receive the Interest Paid Period p, which may include the parameter Period p and may include Intervals i in the Period p.

In an alternative embodiment, interest rate may be negative and interest payment is due to source (e.g., Issuer). In this embodiment, the interest due is received as input.

The Fiat Coin Interest Calculation and Payment Smart Contract may then execute interest time-based pro rata distribution calculations. The Fiat Coin Interest Calculation and Payment Smart Contract first identifies blockchain addresses that have held Fiat Coin during each Interval i during Period p.

In one embodiment, the Fiat Coin Interest Calculation and Payment Smart Contract may query the blockchain database to find all accounts that have Fiat Coin balance in each calculation interval (e.g. 1 day, 1 minute, 1 second). The Fiat Coin Interest Calculation and Payment Smart Contract then records the amounts and balances in a database. The Fiat Coin Interest Calculation and Payment Smart Contract then calculates interest earned/due for each account and the balance is recorded in the database for each calculation interval.

In one embodiment, the calculation of interest may be:

[Interest allocated to Account # for interval i]=[Interest Paid Period p] *[balance Account # for Interval i]/[total account balances for Interval i]/[# intervals n]

The Fiat Coin Interest Calculation and Payment Smart Contract may calculate total interest allocated to each Interval i using the formula:

[Total interest interval i]=[sumInterest(Account #,Account #,Account # . . . )]

The Fiat Coin Interest Calculation and Payment Smart Contract may calculate total interest allocated in aggregate in Period p for all Intervals i as:

[Total interest allocated period p]=[sumInterest(Interval 1,Interval 2,Interval N) . . . ]

The Fiat Coin Interest Calculation and Payment Smart Contract may validate total interest allocated is equal to the total interest paid using the formula:

[Total interest allocated Period p]=[Interest Paid Period p]

In an alternative embodiment, Fiat Coin may be sent from a Fiat Coin owner's blockchain address to a smart contract blockchain address. In this embodiment, Interest is calculated for balances held in the smart contract address(es).

The Fiat Coin Interest Calculation and Payment Smart Contract then determines and implements the interest distribution model. In one embodiment interest may be distributed according to a Coin Minting methodology. In this embodiment, the Fiat Coin Interest Calculation and Payment Smart Contract determines the number of new Fiat Coin(s) to generate based on aggregate interest payment. The Fiat Coin Interest Calculation and Payment Smart Contract then sends instructions to the Fiat Coin Creation Smart Contract. As further described below, the Fiat Coin Creation Smart Contract then mints new Fiat Coins and distributes them to recipient addresses. In one embodiment, the Coins distributed to each account=[Interest allocated to Account # for interval i].

In an alternative embodiment interest may be paid in currenc(ies) other than the underlying fiat balances. In this embodiment, the Smart Contact may calculate interest due in the underlying fiat currency and then retrieve exchange rates for underlying fiat currency to alternative currency from an exchange rate table on the blockchain database. The Fiat Coin Interest Calculation and Payment Smart Contract may then calculate interest due in the alternative currency based on the exchange rate.

In another embodiment of the Fiat Coin Interest Calculation and Payment Smart Contract, interest may be distributed by changing the coin ratio, e.g. in the case of negative interest rates. In this embodiment, new coins may be minted according to the following equation:

[New Coin Ratio]=[Total Fiat Currency Balance]/[Total Fiat Coins in Circulation]

The Fiat Coin Interest Calculation and Payment Smart Contract may then record the new coin ratio to a blockchain database.

In an alternative embodiment rather than creating new Fiat Coins, the Smart Contract burns or otherwise destroys Fiat Coins when fiat currency balances are subject to negative interest rates.

Fiat Coin Ratio Adjustment Smart Contract

In one embodiment, a Fiat Coin Ratio Adjustment Smart Contract is established. The Fiat Coin Ratio Adjustment Smart Contract may create and deploy a smart contract that calculates interest owed/earned and distributes it in the form of an updated conversion ratio.

The Fiat Coin Ratio Adjustment Smart Contract is developed by a programmer skilled in the art and written in a programming language supported by the blockchain platform upon which the smart contract is to be deployed (e.g. Solidity for Ethereum). In operation, the Fiat Coin Ratio Adjustment Smart Contract is compiled into and executable format according to the blockchain platform (e.g EVM bytecode for Ethereum) and is processed according to the blockchain platform (e.g. the Ethereum Virtual Machine, or EVM).

The Fiat Coin Ratio Adjustment Smart Contract is deployed to a blockchain in accordance with standard deployment methodology for the blockchain upon which the smart contract is to be deployed (e.g. a Contract Account on Ethereum).

In operation, in order to adjust the ratio, the Fiat Coin Ratio Adjustment Smart Contract first determined the new ratio of Fiat Coin to the underlying fiat currency. This may be done using the following equation:

[New Coin Ratio]=[Total Fiat Currency Balance]/[Total Fiat Coins in Circulation]

The Fiat Coin Ratio Adjustment Smart Contract then records the new coin ratio to a blockchain database.

In one embodiment the ratio of Fiat Coins to fiat currency increases where the interest earned on fiat currency balances is positive.

In one embodiment the ratio of Fiat Coins to fiat currency decreases where the interest is positive/earned on fiat currency balances (e.g. 1 Fiat Coin converts to 1.01 USD).

In another embodiment the ratio of Fiat Coins to fiat currency increases where the interest is negative/owed on fiat currency balances (e.g. 1 Fiat Coin converts to 0.9 USD)

Interest Distribution—Illustrative Example

In one embodiment of the distributed ledger management system, interest is paid by interest-bearing instrument 1 time per interest period p (e.g. monthly). Further, Period p is divided into N intervals i (e.g. 30 1-day intervals). The dollar amount of Interest is allocated across accounts for each interest interval according to the account balance during the interval as a percentage of total account balances for the interval. Additionally, the interest is allocated for an Interval as a percentage of the total number of intervals (1/number of intervals).

Additionally, the total dollar amount of interest allocated must equal the interest paid by the interest-bearing instrument for the period p. The total allocated interest is calculated as: Per account per interval, Aggregate of all accounts per interval, and Aggregate of all intervals per period.

These relationships are represented in the following equations:

[Interest Paid for Period p]=$ interest payment from interest-bearing instrument

[Interest allocated to Account # for interval i]=[Interest Paid Period p]*[balance Account # for Interval i]/[total account balances for Interval i]/[#intervals n]

[Total interest interval i]=[sumInterest(Account #,Account #,Account # . . . )]

[Total interest allocated period p]=[sumInterest(Interval 1,Interval 2,Interval N)]

[Total interest allocated period p]=[Interest Paid Period p]

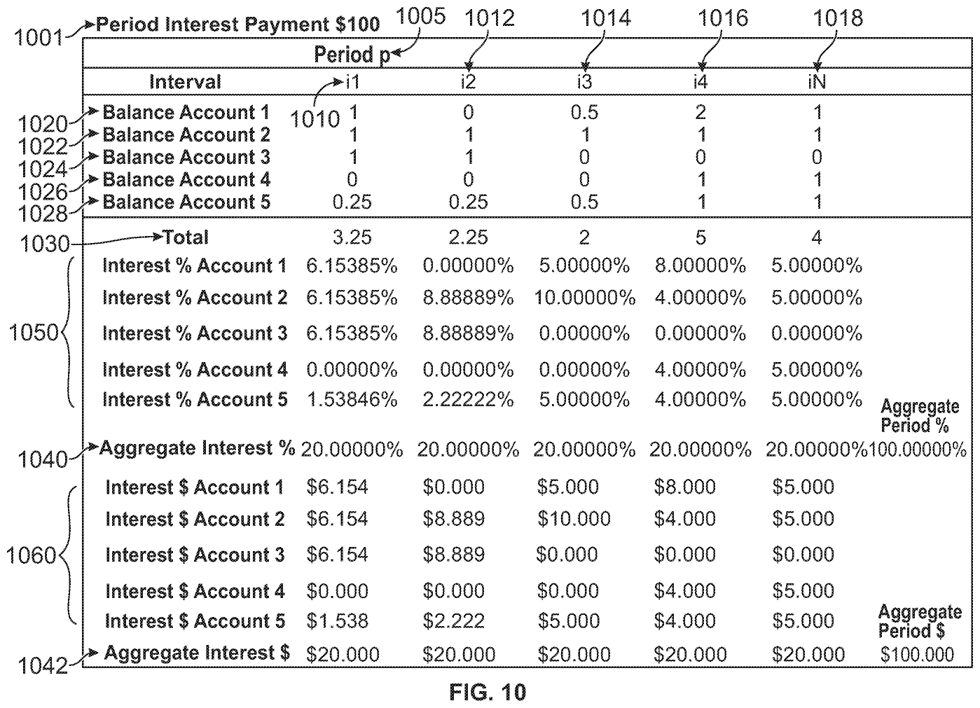

FIG. 10 illustrates an example of the calculation and allocation of interest for multiple accounts over period p having intervals i. More specifically, as shown in FIG. 10, the total interest payment 1001 for the period p has been determined to be $100. There are five account balances 1020-1028 that have had at least some coin value during at least one of the five intervals I 1010-1108 during the period p 1005. Balance Account 1-5 1020-1028 illustrate the coin balance for each account during the respective interval 1010-1018. The balance total 1030, illustrates the total quantity of Fiat Coin that was held by all balance accounts 1022-1028 during the respective interval 1010-1018, and can be seen to vary from interval to interval.

As mentioned above, in one embodiment, the smart contract allocates the aggregate interest uniformly over the five intervals 1010-1018 as shown in the Aggregate Interest Percentage 1040. In this example, because there are 5 intervals 1010-1018, each interval is accorded ⅕^{th} or 20% of the total interest.

Further, because the total interest for the period is $100, the aggregate total interest payment 1042 is allocated in the same fashion as the Aggregate Interest Percentage 1040. Thus, $20 is allocated to each of the five intervals 1010-1018 as shown.

Within an interval, such as the first interval 1010, the Smart Contract then determines for each Balance Account 1022-1028, the ratio of the amount of Fiat Coin that it held during that interval to the total amount of Fiat Coin held during that interval by all Balance Accounts. The Smart Contract then multiplies that value by the Aggregate Interest Percentage 1040 for that interval and displays the result as Interest Percentage for Accounts 1-5 1050. For example, for the first interval 1010, Balance Account 5 1028 held 0.25 Fiat Coin of the total 3.25 Fiat Coin that was held by all accounts during the first interval. Taking the ratio of (0.25 Fiat Coin/3.25 Fiat Coin) and multiplying by the 20% Aggregate Interest for the first interval yields that the Interest percentage for account 5 for the first interval is 1.53846% of the total interest that is payable over the period p.

For all accounts, the Interest Percentage for Accounts 1-5 1050 is then multiplied by the Aggregate period interest 1001 to determine the Interest Dollars for Accounts 1-5 1060. For example, the 1.53846% of interest that was determined above for Balance Account 5 during the first interval is then multiplied by the total interest payable over the period p ($100 in this example) to arrive at the Interest dollars payable to Account 5 for the first interval 1010, in this case $1.538 USD.

Fiat Currency & Fiat Coin Reconciliation Smart Contract

In one embodiment, a Fiat Currency & Fiat Coin Reconciliation Smart Contract is established. The Fiat Currency & Fiat Coin Reconciliation Smart Contract may create and deploy a smart contract that reconciles the on-chain Fiat Coin account balances with off-chain fiat account balances.

The Fiat Currency & Fiat Coin Reconciliation Smart Contract is developed by a programmer skilled in the art and written in a programming language supported by the blockchain platform upon which the smart contract is to be deployed (e.g. Solidity for Ethereum). In operation, the Fiat Currency & Fiat Coin Reconciliation Smart Contract is compiled into and executable format according to the blockchain platform (e.g EVM bytecode for Ethereum) and is processed according to the blockchain platform (e.g. the Ethereum Virtual Machine, or EVM).

The Fiat Currency & Fiat Coin Reconciliation Smart Contract is deployed to a blockchain in accordance with standard deployment methodology for the blockchain upon which the smart contract is to be deployed (e.g. a Contract Account on Ethereum).

In operation, the Fiat Currency & Fiat Coin Reconciliation Smart Contract may receive Fiat Coin reconciliation message and process them in accordance with blockchain computation methodology (e.g. Ethereum Virtual Machine). In one embodiment, the Smart Contract may automatically trigger to process the reconciliation instruction (e.g. at a predetermined and/or scheduled time/date). In another embodiment the Smart Contract may receive a reconciliation instruction transmitted via a Blockchain Node from another entity on or off the blockchain (e.g. the Issuer, a third-party auditor, another Smart Contract, a regulator, etc.).

The Fiat Currency & Fiat Coin Reconciliation Smart Contract may then execute Smart Contract computation in accordance with Smart Contract reconciliation logic. For example, the Fiat Currency & Fiat Coin Reconciliation Smart Contract may query all Fiat Coin balances from public addresses in the blockchain database. The Fiat Currency & Fiat Coin Reconciliation Smart Contract may then sum all balances to compute aggregate Fiat Coin balance recorded on the blockchain database and records in an account database.

In another embodiment or as an additional step in the prior embodiment, the Fiat Currency & Fiat Coin Reconciliation Smart Contract may query Issuer account balances off-chain, for example, as described in the Fiat Currency & Fiat Coin Reconciliation Process below. In an alternative embodiment, the Blockchain Node may transmit balance query to the Issuer's Custody Bank system. The Fiat Currency & Fiat Coin Reconciliation Smart Contract may also record the issuer off-chain account balances in an account database.

In one embodiment, the Fiat Currency & Fiat Coin Reconciliation Smart Contract may execute reconciliation logic. For example, the Fiat Currency & Fiat Coin Reconciliation Smart Contract may retrieve the sum of public address balances from account database. The Fiat Currency & Fiat Coin Reconciliation Smart Contract may then retrieve Issuer off-chain account balances from account database and compare the summed public address balances with Issuer off-chain account balance data. The Fiat Currency & Fiat Coin Reconciliation Smart Contract may then record a reconciliation output to a reconciliation database and may electronically alert that the account balance is properly reconciled—or initiate an automated exception notification. The automated exception notification may be used as a control signal to initiate additional automated account and/or smart contact activity.

Fiat Coin Tax Tracking, Calculation, and Recording Smart Contract

In one embodiment, a Fiat Coin Tax Tracking, Calculation, and Recording Smart Contract is established. The Fiat Coin Tax Tracking, Calculation, and Recording Smart Contract may create and deploy a smart contract that tracks the tax liabilities from gains and/or losses on Fiat Coins and Fiat Coin interest payments.

The Fiat Coin Tax Tracking, Calculation, and Recording Smart Contract is developed by a programmer skilled in the art and written in a programming language supported by the blockchain platform upon which the smart contract is to be deployed (e.g. Solidity for Ethereum). In operation, the Fiat Coin Tax Tracking, Calculation, and Recording Smart Contract is compiled into and executable format according to the blockchain platform (e.g EVM bytecode for Ethereum) and is processed according to the blockchain platform (e.g. the Ethereum Virtual Machine, or EVM).

The Fiat Coin Tax Tracking, Calculation, and Recording Smart Contract is deployed to a blockchain in accordance with standard deployment methodology for the blockchain upon which the smart contract is to be deployed (e.g. a Contract Account on Ethereum).

In operation, in order to perform tax tracking, the Fiat Coin Tax Tracking, Calculation, and Recording Smart Contract tracks each new Fiat Coin issued for the payment of interest. For example, the Fiat Coin Tax Tracking, Calculation, and Recording Smart Contract may query all public addresses for interest payments in an interest payment interval i and/or period p and may then record the interest payments in an account database.

In another embodiment the Smart Contract tracks profits and/or losses made from Fiat Coin appreciation or depreciation basis Fiat Currency at a conversion rate at the time of a Fiat Currency equivalent transaction. For example, the Fiat Coin Tax Tracking, Calculation, and Recording Smart Contract may query blockchain database for all transactions in Fiat Coin. The Fiat Coin Tax Tracking, Calculation, and Recording Smart Contract may then query the blockchain database for current conversion ratio/rate to Fiat Currency equivalent at the time of the transaction. This may include one or more of the rate of Fiat Coin to Fiat Currency or the rate of Fiat Coin to [any other asset]. Additionally, other assets may be priced in Fiat Currency or may be priced in currency other than Fiat Currency at the conversion rate to Fiat Currency.

The Fiat Coin Tax Tracking, Calculation, and Recording Smart Contract may then calculate profit/loss (on either the Fiat Currency or Fiat Coin basis) and then record the profit/loss in an account database for each public address with one or more Fiat Coin transactions.

In one embodiment of Tax Calculation & Recording, the Fiat Coin Tax Tracking, Calculation, and Recording Smart Contract may query the blockchain account database for profit/loss and may then execute a tax liability calculation on the profit/loss. This tax liability calculation may be based on the relevant tax jurisdiction of the account and/or public address. For example, in one embodiment, the account and/or the public address may be electronically associated with a tax jurisdiction in a tax jurisdiction database. The tax jurisdiction database may be located on the Blockchain or embodied as a private, secured database. In addition to storing a tax jurisdiction for an account and/or public address, the tax jurisdiction database may include specific calculations that retrievable by the Smart Contact to perform to establish the tax liability for the specific account and/or public address.

In one example, the Fiat Coin Tax Tracking, Calculation, and Recording Smart Contract may determine that the account and/or public address is subject to U.S. taxes. Consequently, the Fiat Coin Tax Tracking, Calculation, and Recording Smart Contract retrieves and calculates taxes for the account and/or public address using the U.S. IRS Tax Code—for example, (profit or loss*30%).

The Fiat Coin Tax Tracking, Calculation, and Recording Smart Contract also records the tax liability in a tax database for each public address and/or account with one or more Fiat Coin transactions.

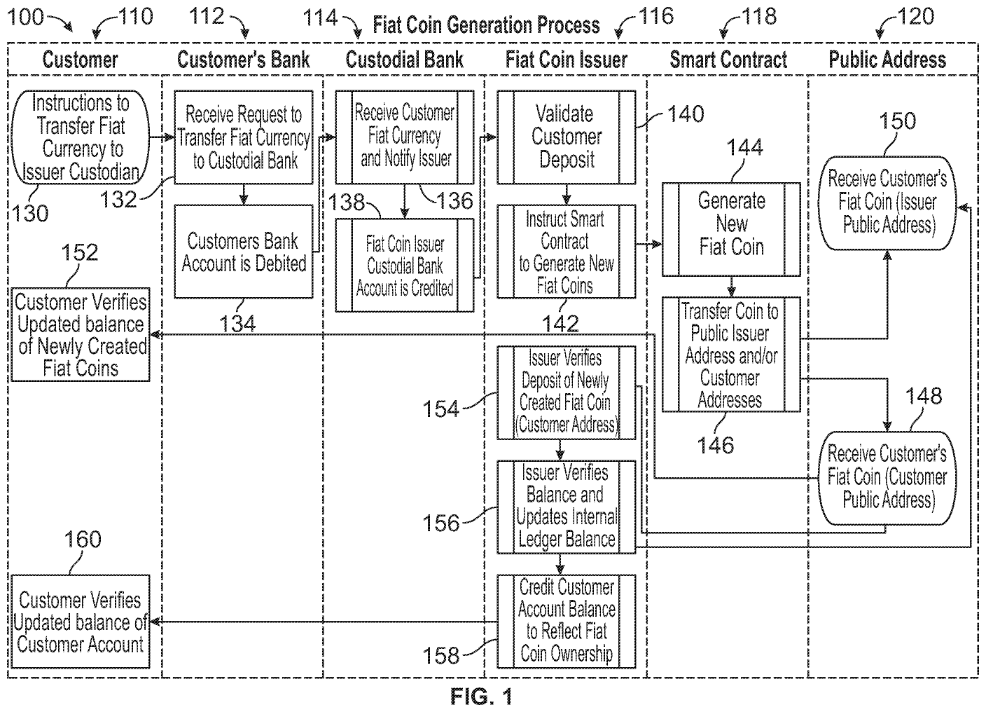

FIG. 1 illustrates an embodiment of the Fiat Coin generation process 100 according to an embodiment of the distributed ledger management system. The Fiat Coin generation process 100 shown in FIG. 1 illustrates multiple vertical columns representing computerized systems including a customer system 110, a customer bank system 112, a custodial bank system 114, a fiat coin issuer system 116, a smart contract 118 and a public address 120.

The first step in the Fiat Coin generation process 100 is Fiat Currency Transfer. To initiate the Fiat Currency Transfer, the Customer instructs fiat currency transfer from Customer Bank Account to Issuer Custodial Bank Account at step 130.

In one embodiment, the Customer system submits fiat currency transfer request from system endpoint. The system endpoint (e.g. mobile applications, PC, server) transmits request including data elements over a network to receiving system at Customer Bank. In one embodiment the network is a public network such as the Internet. In another embodiment the network is a private network.

At step 132, the Customer Bank system receives request and validates and processes the transfer instructions. For example, the customer bank may validates that the customer has sufficient funds to transfer, for example by querying an account balance associated with the customer that is stored in an account database.

At step 134, the customer bank updates its transaction database to reflect transfer record. The customer bank also updates Customer account records stored in an account database to reflect account balance updates. For example, the customer bank reduces the Customer account balance account database record by transfer amount

The Customer Bank system then issues a transfer request and transmits request, with data elements, over a network to the Custodial Bank system. In another embodiment the Customer Bank may transmit a request to a Central Bank (e.g. the U.S. Federal Reserve, Bank of Canada, European Central Bank). This may be done in accordance with existing standard commercial bank and central bank fiat currency transfer processes

At step 136, the Custodial Bank system receives request and validates and processes instructions and data elements of the transaction. For example, at step 138, the Custodial Bank may update Issuer account records stored in an account database to reflect account balance updates. In one embodiment, this involves recording the inbound transfer in a transaction database and increasing the Issuer account balance in account database record by the transfer amount.

The Custodial Bank may also determine the interest earning mechanism. In one embodiment, deposited funds may be automatically debited by the Custodial Bank system from the Issuer account balance in the Custodial Bank system and credited to another account. In an example embodiment, funds may be used to purchase shares in a money market fund. In another embodiment, funds may be used to enter into a repurchase transaction with an eligible counterparty

In another embodiment, the Custodial Bank system may automatically calculate a distribution of funds across multiple interest earning sources. In an example embodiment, funds may be used to purchase shares in a multiple money market funds. In another embodiment, funds may be used to enter into a repurchase transaction with multiple eligible counterparties

In another embodiment, a Customer may have the choice of interest mechanism, e.g. money market, repo, etc. In this embodiment, the Customer system requests available interest mechanisms using a system endpoint. For example, the system endpoint submits request for a list of available interest mechanism smart contracts from a database and displays a list of interest mechanism option descriptions corresponding to an underlying smart contract for each option and/or smart contract. Further, the Customer's pre-existing balances for each smart contract (if any) may be retrieved from a database associated with that customer and populated in the displayed listing.

Next, the Customer selects to submit a request to allocate coins to one or more smart contracts and/or interest options using a system endpoint. In one embodiment, the Customer enters a new total amount of coins in the system endpoint for allocation to each smart contract/interest option. In another embodiment, the Customer enters a percentage of total coins in the system endpoint for each smart contract/interest option.

The Customer then submits the newly allocated interest mechanism option request. The system endpoint submits request to the smart contract(s). The smart contracts then update the relevant databases as described herein. The smart contract may also call the database to display the newly allocated balances back to system endpoint.

Next, the process proceeds to Fiat Coin Generation, wherein the Customer requests Fiat Coin generation with the Issuer system. First, the customer system submits a Fiat Coin generation request from system endpoint and the system endpoint transmits the request including data elements over a network to receiving system at Issuer system 116.

At step 140, the Issuer System 116 receives the request and verifies the Customer's deposit at the Custodian Bank. For example, the Issuer System may transmit an account balance and transaction history query over a network to Custodian Bank and may then receive an account balance and transaction history response over a network from Custodian Bank.

The Issuer System then compares the received transaction history with transaction history stored on the Issuer's transaction database. The Issuer System also compares the account balance with the account balance stored on Issuer account database. The Issuer System also updates its internal transaction database to reflect the changes indicated in Custodial Bank transaction history data. The Issuer System also updates its internal account database to reflect changes indicated in the Custodial Bank account balance data. For example, the Issuer System may update a Customer account balance on Issuer account database—for example to increase the customer account balance to reflect deposit.

Next, at step 142, the Issuer System sends a Fiat Coin generation instruction to a Blockchain Node System over a network including a Smart Contract public address. At the Blockchain Node System, the instruction is received. The System then transmits a Fiat Coin generation instruction over a network to a Smart Contract. The generation instruction may include the public address of a target Smart Contract.

The Blockchain Node Systems may receive the Fiat Coin generation instruction message and process it in accordance with blockchain computation methodology (e.g. Ethereum Virtual Machine).

For example, at step 144, the smart contract computation may be executed to process the instructions to generate new Fiat Coin. The instructions may include the number of Fiat Coins to generate, the type of Fiat Coins to generate, and the designated public address(es) in the Blockchain Database to which the coins are to be allocated. For example, this may involve increasing public address balance(s) including customer address(es) at step 148 and/or issuer address(es) at step 150

Next, the Smart Contract may record the Fiat Coin generation transaction message to blockchain database in accordance with blockchain mining/consensus methodology (e.g. proof-of-work, proof-of-stake, or other consensus mechanism). (See https://en.bitcoin.it/wiki/Proof_of_work, https://github.com/ethereum/wiki/wiki/Proof-of-Stake-FAQ, https://masterthecrypto.com/guide-to-consensus-algorithms-what-is-consensus-mechanism/)

At step 152, the Customer may verify the updated balance of newly created Fiat Coins using the Customer endpoint system (e.g. mobile applications, PC, server). For example, the endpoint system may transmit an account balance query over a network to Blockchain Node. The Blockchain Node may then inspect the public address account balance on the blockchain in the Blockchain Database. The Blockchain Node may then transmit an account balance query response over the network. The Customer endpoint system may then receive the account balance query response and present/display the balance data to the Customer. This may be done using a database or using a user interface.

At step 154, the Issuer System may verify the deposit of the newly created Fiat Coin. For example, the Issuer System may verify the deposit by querying the database associated with the customer public address to determine that the Fiat Coin amount associated with the customer public address has been incremented by the desired amount.

At step 156, the Issuer System may verify the customer balance on its internal databases and update the internal ledger database. The process then proceeds to step 158 where the Issuer System credits the customer account balance to reflect ownership of the newly created Fiat Coin. Finally, at step 160, the Customer System may verify the updated balance of the Customer Account at the Issuer System.

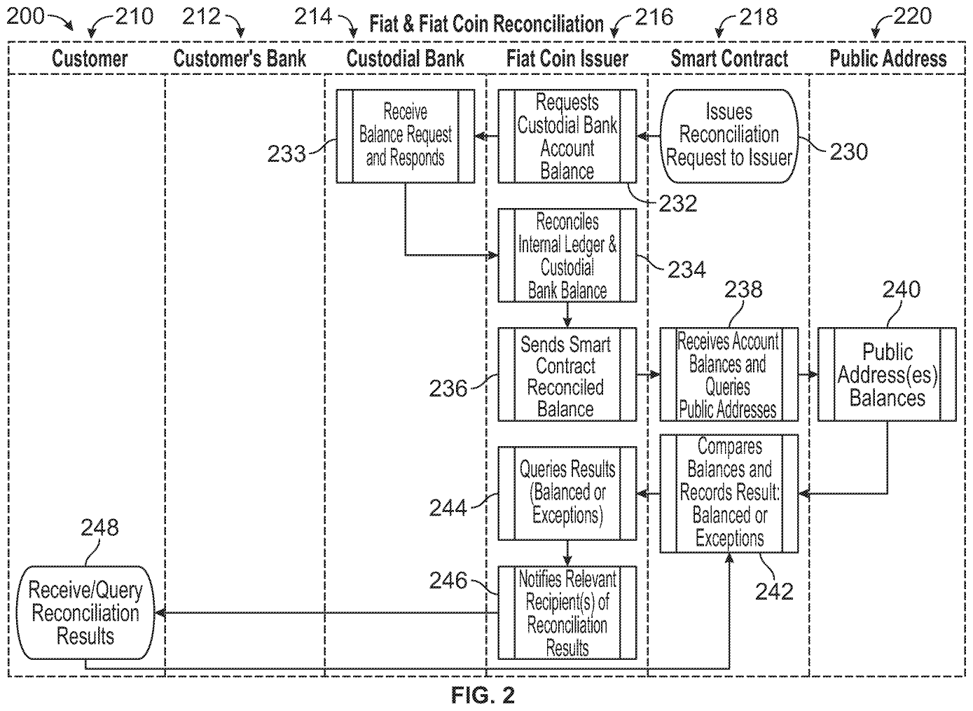

FIG. 2 illustrates an embodiment of the Fiat Currency and Fiat Coin Reconciliation process 200 according to an embodiment of the distributed ledger management system. The process 200 shown in FIG. 2 illustrates multiple vertical columns representing computerized systems including a customer system 210, a customer bank system 212, a custodial bank system 214, a fiat coin issuer system 216, a smart contract 218 and a public address 220. The Fiat Currency and Fiat Coin Reconciliation process represents an Off-chain and on-chain balance reconciliation process.

In the Fiat Currency and Fiat Coin Reconciliation process, the Blockchain Node Systems may receive a Fiat Coin reconciliation message and process it in accordance with blockchain computation methodology (e.g. Ethereum Virtual Machine). In one embodiment, the Smart Contract may automatically trigger to process the reconciliation instruction (e.g. at a predetermined and/or scheduled time/date). In another embodiment, the Smart Contract may receive a reconciliation instruction transmitted via a Blockchain Node from another entity on or off the blockchain (e.g. the Issuer, a third-party auditor, another Smart Contract, a regulator, etc.).

The Blockchain Node Systems may then execute Smart Contract computation in accordance with Fiat Currency & Fiat Coin Reconciliation Smart Contract reconciliation logic as previously described. In one embodiment, the Blockchain Node System requests reconciled balances and reconciled balance state (reconciled, exception) from blockchain database, transmits balance number and balance state to the system endpoint, and the system endpoint updates an off-chain database with the balance number and the balance stated. This may involve web-based system endpoints, e.g. Customer System Endpoint and/or may query the off-chain database over a network. The system endpoint may then display the balance number and/or balance state.

Turning to FIG. 2, at step 230, the smart contract 218 may issue a reconciliation request to the Issuer system 216. At step 232, the issuer system requests the custodial bank account balance. Next, at step 233, the custodial bank 214 receives the balance request and responds with the balance.

At step 234, the issuer system then reconciles its internal ledger and balance received from the custodial bank. Then, at step 236, the issuer system 216 sends a smart contract reconciled balance to the smart contract. At step 238, the smart contract 218 receives the account balances and then queries the public addresses that are associated with owning Fiat Coin. At step 240, the public address(s) balances are retrieved.

Next, at step 242, the smart contract 218 compares reconciled balances to the received public address balances and records the result as to whether the they are balanced or there is an exception. At step 244, the issuer system 216 queries the result of the comparison from the smart contract (including whether each account balances or there is an exception.) Next, at step 246, the issuer system 216 notifies the relevant recipient(s) of the reconciliation results. Finally, the customer system 210 receives the reconciliation results. Additionally, the customer system 210 may transmit a request for reconciliation results to the smart contract 218 at step 242.

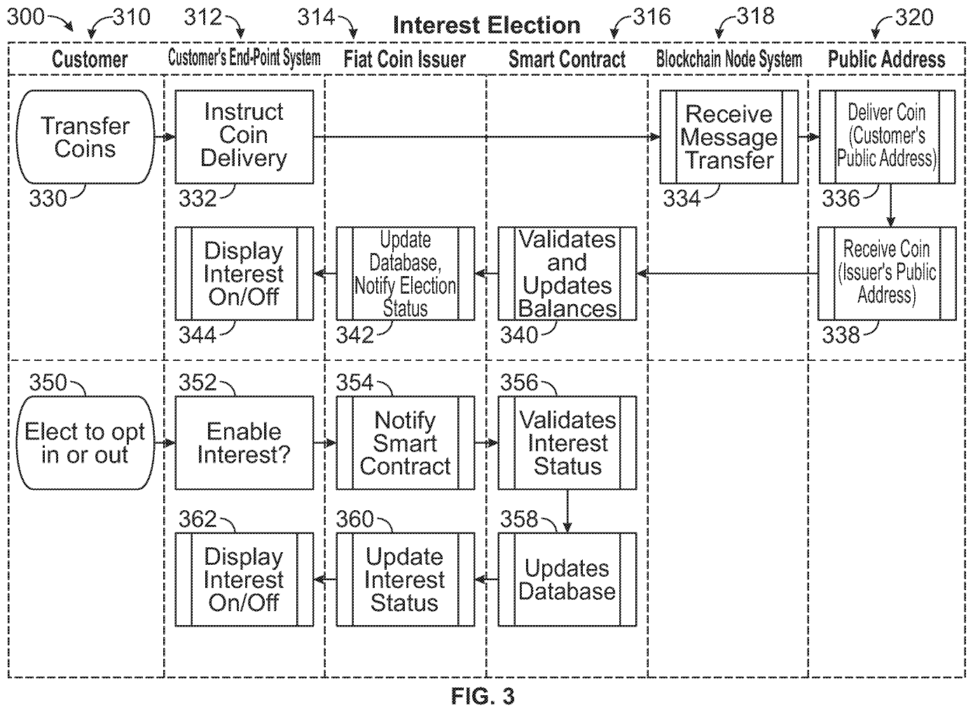

FIG. 3 illustrates an embodiment of the Interest Election process 300 according to an embodiment of the distributed ledger management system. The process 300 shown in FIG. 3 illustrates multiple vertical columns representing computerized systems including a customer 310, a customer end-point system 312, a fiat coin issuer system 314, a smart contract 316, a blockchain node system 318, and a public address 320. The Fiat Currency and Fiat Coin Reconciliation process represents an Off-chain and on-chain balance reconciliation process.

In one embodiment, a default may be established so that the Customer opts-out of the Fiat Coin interest election. In another embodiment, Customer 310 may submit an instruction electing to opt into interest participation from system endpoint. The system endpoint (e.g. mobile applications, PC, server) may transmit an instruction including data elements over a network to a Blockchain Node including Smart Contract public address

At the Blockchain Node System, in one embodiment, coins are transferred to the Smart Contract public address. In another embodiment, coins are transferred to a designated wallet with a link into the Smart Contract. In a further embodiment, coins are transferred to a different designated wallet. The transfer mechanism may follow the Fiat Coin transfer process outlined below.

In one embodiment of the interest election process, the Customer is defaulted for opt-in. In another embodiment, the Customer may submit instructions electing to opt out of interest participation from system endpoint. In an additional embodiment, the Customer does not explicitly opt-out of interest participation, but by not actively opting in, Customer by default opts out. The customer's system endpoint may then update opt in/out status and display it on user interface.

Turning to the interest election process 300 shown in FIG. 3, at step 330, the Customer 310 transfers coins as described herein by causing the customer's end-point system to transmit instructions to implement coin delivery, as shown at step 332. At step 334, the blockchain node system 318 receives the transfer message. Next, at step 336, the coins are delivered to the customer's public address 320. Then, at step 338, the coins are received by the issuer's public address.

At step 340, the smart contract 316 validates and updates the balances associated with the public addresses and customer accounts. At step 342, the fiat coin issuer 314 updates its databases and notifies the customer's end-point system 312 of the interest election status. Next, at step 344, the customer's end-point system displays whether interest election is on or off for the transferred coins.

Additionally, a customer having multiple deposits may select an interest on/off status individually for each deposit. Alternatively, the customer may segment a deposit so that interest on/off status is only activated for a percentage of the deposit.

At step 350, the customer 310 may elect to opt in or opt out of interest and will cause the customer's end-point system 312 to enable/disable interest at step 352. At step 354, the fiat coin issuer receives the customer selection and notifies the smart contract 316. Next, at step 356, the smart contract validates the interest status, for example by confirming the account balance of the customer. At step 358, the smart contract 316 updates its database to reflect the interest election received from the customer 310.

Next, at step 360, the fiat coin issuer 314 then updates the interest status reflected in its internal databases. At step 362, the issuer transmits the updates interest election status to the customer's end-point system 312, where it is displayed.

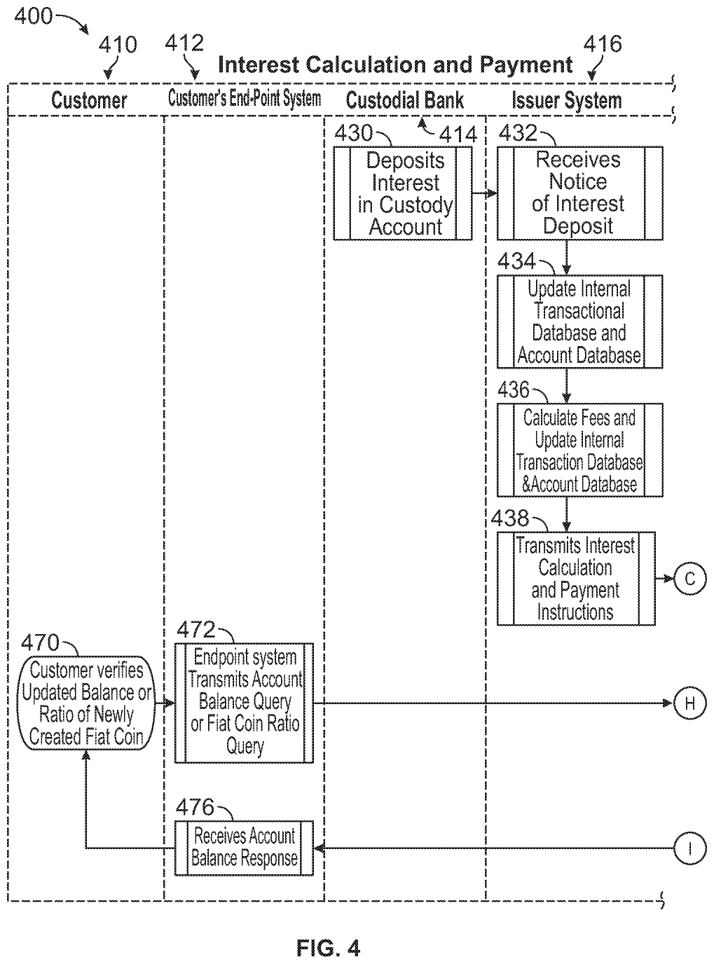

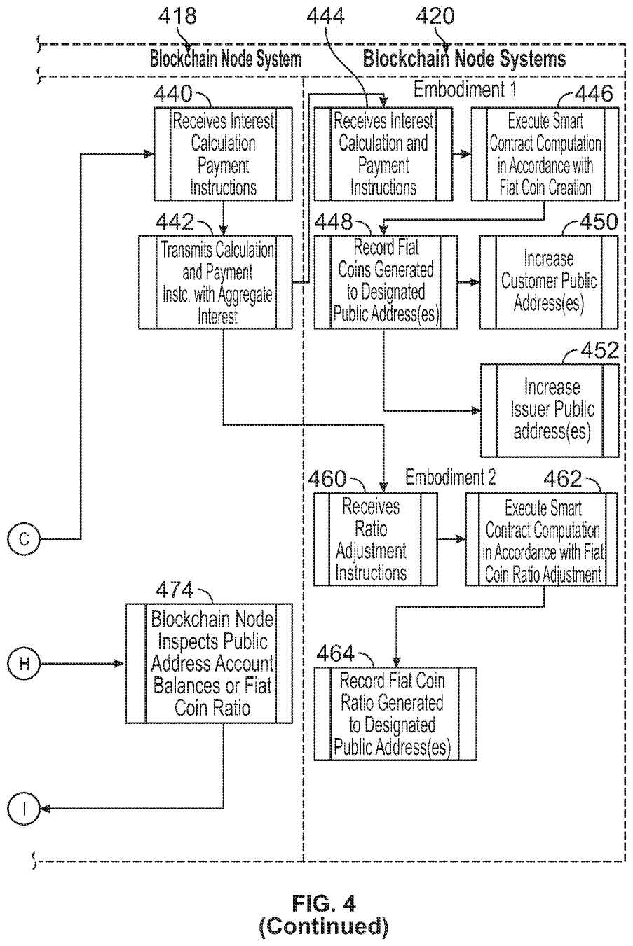

FIG. 4 illustrates an embodiment of the interest calculation and payment process 400 according to an embodiment of the distributed ledger management system. The process 400 shown in FIG. 4 illustrates multiple vertical columns representing computerized systems including a customer 410, a customer end-point system 412, a custodial bank 414, a fiat coin issuer system 416, a blockchain node system multi-embodiment elements 418, and blockchain node system separate-embodiment elements 420.

In one embodiment, starting at step 430, the custody bank system 414 updates its account database to reflect newly deposited interest in Issuer custody account and sends a notification of interest payment including the updated Issuer account balance over a network to Issuer system. The Issuer system 416 then receives notice of the interest deposit in the Issuer Custody Account from the Issuer Custody Bank at step 432.

At step 434, the issuer system updates its internal transaction database to reflect changes indicated in Custodial Bank transaction data. Next, at step 436, the issuer system calculates Issuer fees and updates its internal transaction database and account database to reflect the deduction of fees. The Issuer system then updates its account balance on the Issuer account database. Then, at step 438, the issuer system transmits interest calculation and payment instruction over a network to the Blockchain Node System 418 including Smart Contract public address.

At step 440, the Blockchain Node System receives the interest calculation payment instruction. Then, at step 442, the Blockchain Node System transmits the interest calculation and payment instruction including the aggregate interest payment over a network to Blockchain Node Systems of the two separate embodiments. The interest calculation and payment instructions may include the public address of the target Smart Contract

In a first embodiment, as shown at step 444, the blockchain node systems 420 receive interest calculation and payment instructions and process them in accordance with blockchain computation methodology (e.g. Ethereum Virtual Machine). At step 446, the blockchain node system executes a Smart Contract computation in accordance with Fiat Coin Interest Calculation and Payment Smart Contract logic to calculate the interest time-based pro rata distribution as previously described.

At step 448, the fiat coins that have been generated are recorded to their respective public addresses. In one embodiment, this includes transmitting a Fiat Coin generation instruction over a network to Blockchain Node Systems, including public address of target Smart Contract. At step 450, the public address(es) of the customer are increased. At step 452, the Issuer public address(es) are increased.

In another embodiment, at step 460, the Blockchain Node System received the ratio adjustment instructions—and at step 462 executes Smart Contract computation in accordance with Fiat Coin Ratio Adjustment Smart Contract logic to adjust the Fiat Currency to Fiat Coin ratio as previously described. The Blockchain Node System receives the Fiat Coin ratio adjustment instruction over a network, the instruction including the public address of the target of the Smart Contract. At step 464, the blockchain node system records the fiat coin ratio to the designated public address(es).

In another embodiment, the Blockchain Node System executes Smart Contract computation in accordance with Fiat Coin Interest Calculation to calculate pro-rata distribution based on set of Customer addresses that have opted into interest participation as previously described. For example, the system may transmit a Fiat Coin ratio adjustment instruction over a network to Blockchain Node Systems, the instruction include the public address of target Smart Contract. Further, public addresses that have opted out in one embodiment, or not explicitly opted in in another embodiment, do not receive interest.

In one embodiment of the Blockchain Node Systems, they receive interest calculation and payment instructions and process them in accordance with blockchain computation methodology (e.g. Ethereum Virtual Machine). The Blockchain Node System then executes Smart contract computation in accordance with Fiat Coin Creation Smart Contract logic as previously described. The Blockchain Node System records Fiat Coins that have been generated to designated public address(es) in the blockchain database in accordance with mining/consensus methodology (e.g. proof-of-work, proof-of-stake). Then, the Blockchain Node System increases the public address balance(s) of the customer address(es) and issuer address(es).

In another embodiment, the Blockchain Node System receives ratio adjustment instructions and process them in accordance with blockchain computation methodology (e.g. Ethereum Virtual Machine) in order to execute Smart contract computation in accordance with Fiat Coin Ratio Adjustment Smart Contract logic as previously described. In this embodiment, the Blockchain Node System records the Fiat Coin ratio that has been generated to the designated public address(es) in the blockchain database in accordance with mining/consensus methodology (e.g. proof-of-work, proof-of-stake). Then, the Blockchain Node System increases the public address balance(s) of the customer address(es) and issuer address(es).

In one embodiment, at step 470, the Customer 410 verifies the updated balance of newly created Fiat Coins using the endpoint system (e.g. mobile applications, PC, server). At step 471, the End-point system 412 transmits an account balance query over a network to Blockchain Node System 418. At step 474, the Blockchain Node System inspects the public address account balance on the blockchain in the Blockchain Database and transmits an account balance query response over a network. At step 476, the Customer endpoint system (e.g. mobile applications, PC) receives the account balance query response and presents balance data to Customer, for example using a database of a user interface.

In another embodiment, Customer verifies the updated ratio of the newly created Fiat Coins using the endpoint system (e.g. mobile applications, PC, server). In this embodiment, the endpoint system transmits Fiat Coin ratio query over a network to Blockchain Node, the Blockchain Node inspects public address ratio data on blockchain in the Blockchain Database, and then transmits a Fiat Coin ratio query response over a network to the Customer endpoint system. The Customer endpoint system (e.g. mobile applications, PC) receives the account balance query response and presents the balance data to Customer, for example using a database or a user interface.

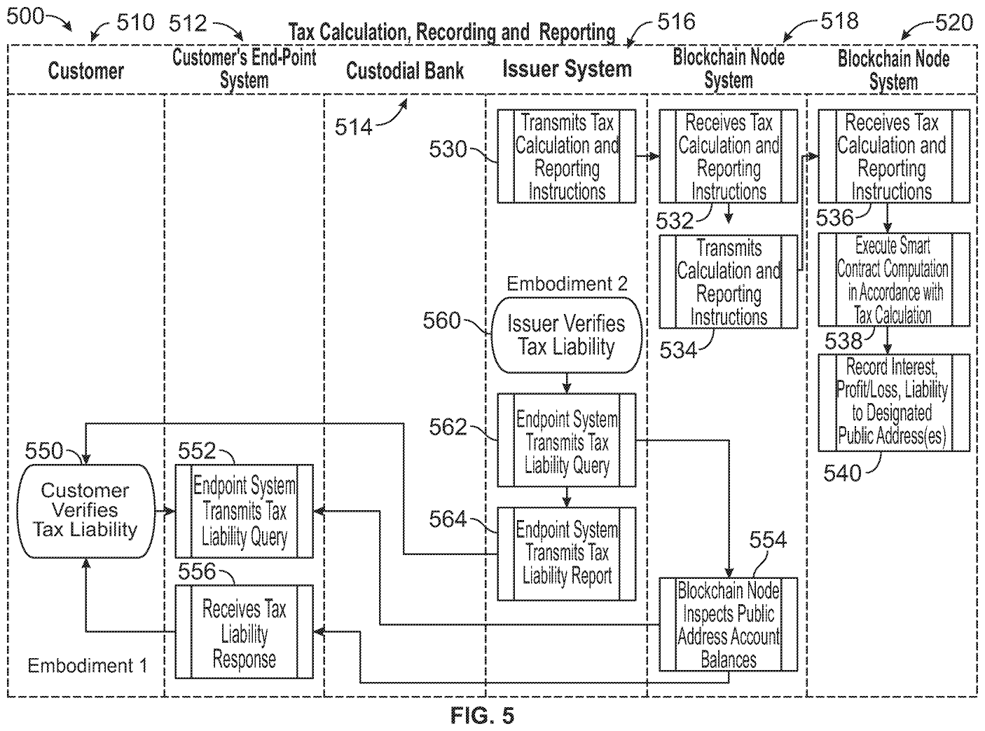

FIG. 5 illustrates an embodiment of the Tax Calculation, Recording and Reporting process 500 according to an embodiment of the distributed ledger management system. The process 500 shown in FIG. 5 illustrates multiple vertical columns representing computerized systems including a customer 510, a customer end-point system 512, a custodial bank 514, a fiat coin issuer system 516, first blockchain node systems 518, and second blockchain node systems 420.

In a first embodiment of the Tax Calculation, Recording and Reporting process 500, the process begins at step 530 where the issuer system 516 transmits tax calculation and reporting instruction over a network to the first Blockchain Node System 518 including Smart Contract public address. At step 532, the first Blockchain Node System 518 receives the tax calculation and reporting instruction—and at step 534, transmits the tax calculation and reporting instructions over a network to the second Blockchain Node Systems 520. The tax calculation and reporting instructions include the public address of a target Smart Contract.

At step 536, the second blockchain node systems 520 receive the tax calculation and reporting instructions and process in accordance with blockchain computation methodology (e.g. Ethereum Virtual Machine). At step 538, the system executes Smart contract computation in accordance with Fiat Coin Tax Calculation and Recording Smart Contract logic as previously described. Then, at step 540, the second blockchain node systems 520 record taxable interest, taxable profit/loss, tax liability generated to designated public address(es) in the blockchain database in accordance with mining/consensus methodology (e.g. proof-of-work, proof-of-stake).

At step 550, in one embodiment, a Customer 510 verifies updated tax calculation using the endpoint system 512 (e.g. mobile applications, PC, server). At step 552, the endpoint system transmits the tax liability query over a network to Blockchain Node. At step 554, the Blockchain Node inspects the identified public address for taxable interest, taxable profit/loss, tax liability on blockchain in the Blockchain Database. Then, the Blockchain Node transmits the tax liability query response over a network and, at step 556, the Customer endpoint system (e.g. mobile applications, PC) receives account balance query response and presents balance data to Customer, for example by using a database and/or a user interface.

At step 560, in another embodiment, the Issuer verifies the updated tax calculation using the endpoint system (e.g. mobile applications, PC, server). In this embodiment, at step 562, the endpoint system transmits a tax liability query over a network to Blockchain Node. The Blockchain Node inspects the public address for taxable interest, taxable profit/loss, tax liability on blockchain in the Blockchain Database. Then, the Blockchain Node transmits a tax liability query response over a network.

The Issuer endpoint system (e.g. mobile applications, PC) then receives the account balance query response and presents balance data to Issuer, for example using a database or a user interface. Further, at step 564, the Issuer endpoint system then generates report to Customer and/or the customer endpoint system, for example, using e-mail and/or a user interface.

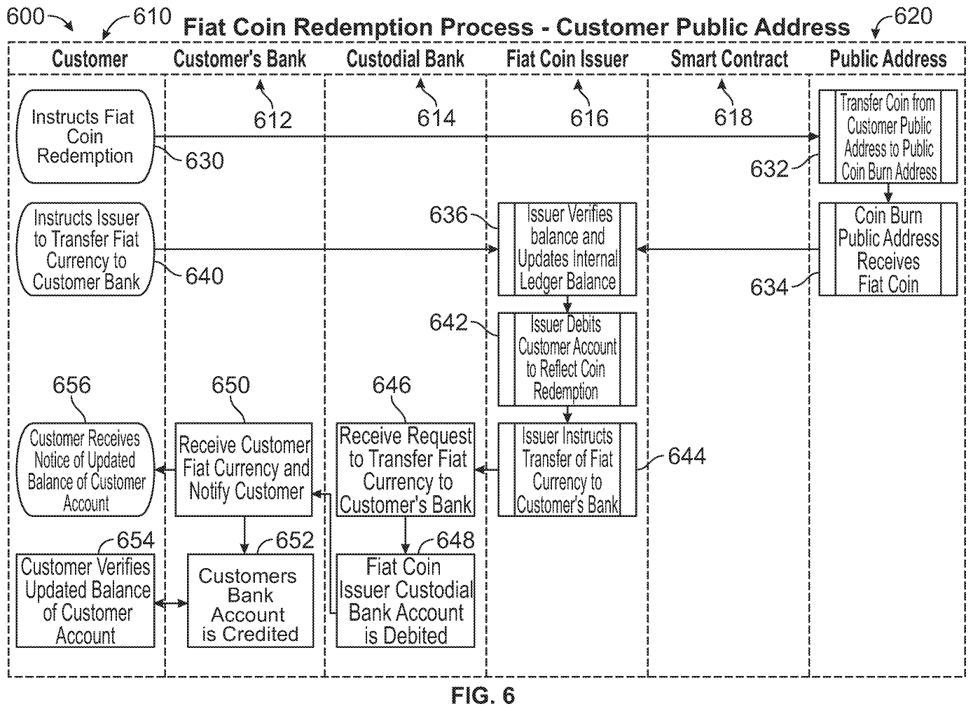

FIG. 6 illustrates an embodiment of the Fiat Coin Redemption to a Customer Address process 600 according to an embodiment of the distributed ledger management system. The process 600 shown in FIG. 6 illustrates multiple vertical columns representing computerized systems including a customer 610, customer's bank 612, a custodial bank 614, a fiat coin issuer system 616, a smart contract 618, and a public address 620. In the Fiat Coin Redemption to a Customer Address process 600, a customer instructs and redeems their Fiat Coin through the Blockchain.

First, at step 630, the Customer submits Fiat Coin redemption instruction from system endpoint. The system endpoint (e.g. mobile applications, PC, server) then transmits the instruction including data elements over a network to a Blockchain Node including Smart Contract public address. The Blockchain Node System then receives redemption instruction message and transmits a Fiat Coin redemption instruction over a network to other Blockchain Node Systems. These Blockchain Node Systems receive the Fiat Coin redemption message and process it in accordance with blockchain computation methodology (e.g. Ethereum Virtual Machine). The Blockchain Node Systems also execute a Smart Contract computation to process the instruction in accordance with the blockchain Smart Contract methodology. The instructions include the amount of Fiat Coin to redeem, the public address to redeem from, and the burn address to send the Fiat Coin to.

Next, the Blockchain Node Systems record the Fiat Coin redemption transaction to a blockchain database in accordance with mining/consensus methodology (e.g. proof-of-work, proof-of-stake). At step 632, the Blockchain Node Systems decrease the balance(s) of the redeeming public address including the customer address(es) and/or the issuer address(es). Then, at step 634, the Blockchain Node System increases the balance at the burn public address.

At step 636, the Issuer 616 then verifies the balance and updates their internal ledger balance with regard to the transaction. Further, the customer verifies updated balance of redeemed Fiat Coins on blockchain using the endpoint system. For example, the endpoint system may transmit an account balance query over a network to Blockchain Node. The Blockchain Node may then inspect the public address account balance on the blockchain in the Blockchain Database. Next, the Blockchain Node may transmit an account balance query response over a network to the Customer endpoint system. Then, the Customer endpoint system may receive the account balance query response and present balance data to Customer, for example using a database or a user interface.

FIG. 6 also illustrates a process for Fiat Currency Withdrawal, where a Customer instructs a fiat currency withdrawal from Issuer to a Customer Bank Account. First, at step 640, the Customer submits fiat currency withdrawal request from the customer system endpoint. The system endpoint (e.g. mobile applications, PC, server) transmits the withdrawal request including data elements over a network to receiving system at Issuer 616.

At the Issuer 616, at step 636, the Issuer system receives the withdrawal request and validates and processes the withdrawal instructions. In one embodiment, the Issuer system transmits a burn validation query over a network to the Blockchain Node. The Blockchain Node then inspects the public address burn account balance on the blockchain in the Blockchain Database and transmits a burn account balance query response over a network to Issuer system. The Issuer system receives the account balance query response and records it in a transaction database. The Issuer system may also present the balance query response on a user interface.

The Issuer system 616 then validates that the customer has sufficient fiat currency funds to withdraw. For example, the Issuer system may query an account balance stored in an account database. The issuer system may then update its transaction database to reflect a withdrawal record and may update Customer account records stored in an account database to reflect account balance updates.

Next, at step 642, the issuer system reduces the Customer account balance account database record by withdrawal amount to reflect the coin redemption. At step 644, the issuer system issues a transfer request to transfer fiat from Issuer account at Custodial Bank 614 to the Customer account at Customer Bank 612. The Issuer transmits the transfer request, with data elements, over a network to a system at the Custodial Bank.

At step 646, the Custodial Bank system 614 receives the transfer request and then validates and processes the transfer instructions and the data elements of transaction. In one embodiment, the custodial bank system updates the Issuer account records stored in an account database to reflect account balance updates. The update may include recording an inbound transfer in a transaction database and decreasing an Issuer account balance in account database record by the transfer amount, as shown at step 648.

The Custodial Bank system 614 may then issue a transfer request to the Customer's bank system 612. The request may be transmitted, with data elements, over a network to system at Customer Bank. In another embodiment, the Customer Bank may transmit a request to a Central Bank (e.g. the U.S. Federal Reserve) in accordance with existing standard commercial and central bank fiat currency transfer processes.

Next, at step 650, the Customer Bank system 612 receives the transfer request and validates and processes the transfer instructions and data elements of the transaction. The customer bank may update the Customer account records stored in an account database to reflect the account balance updates. Additionally, the customer bank may record the inbound transfer in a transaction database. Next, at step 652, the customer bank may increase the Customer account balance in its account database record by the transfer amount.

Next, at step 654, the Customer verifies the updated balance of redeemed fiat currency at the Customer Bank using the customer endpoint system (e.g. mobile applications, PC, server). In one embodiment, the customer endpoint system transmits an account balance query over a network to Customer Bank. The Customer Bank system then inspects the Customer account balance in an account database and transmits am account balance query response with an account balance response over a network to the customer endpoint system.

At step 656, the Customer endpoint system receives the account balance query response and presents balance data to the Customer, for example by using a database and/or a user interface.

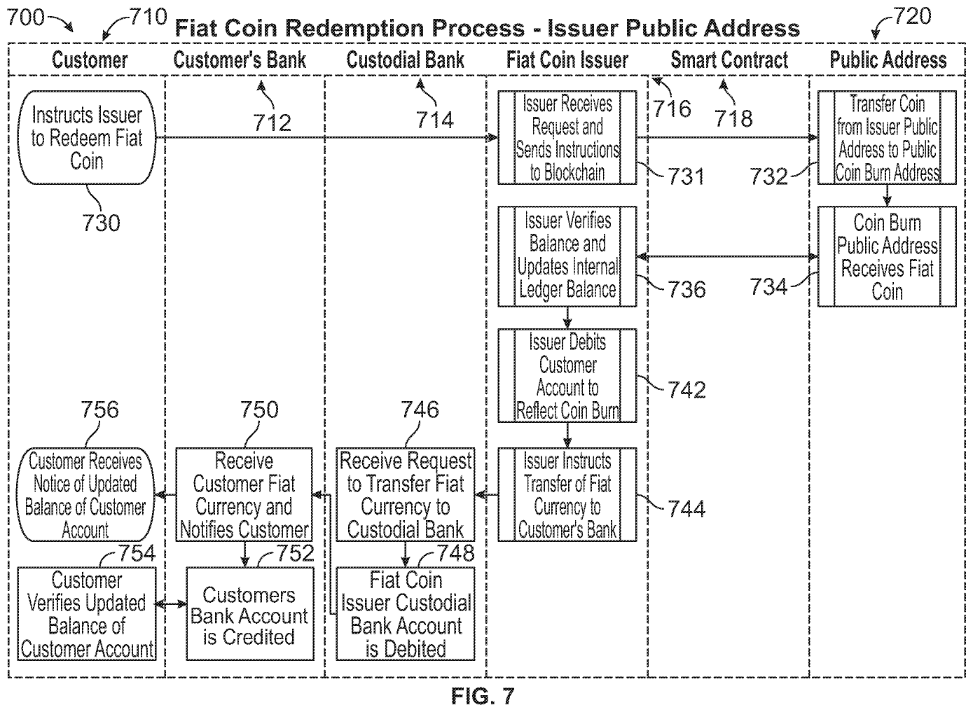

FIG. 7 illustrates an embodiment of the Fiat Coin Redemption to an Issuer Address process 700 according to an embodiment of the distributed ledger management system. The process 700 shown in FIG. 7 illustrates multiple vertical columns representing computerized systems including a customer 710, customer's bank 712, a custodial bank 714, a fiat coin issuer system 716, a smart contract 718, and a public address 720. In the Fiat Coin Redemption to a Issuer Address process 700, instead of redeeming their Fiat Coin directly through the Blockchain, a customer send instructions to an Issuer who then instructs and redeems their Fiat Coin through the Blockchain.

First, at step 730, the Customer submits a Fiat Coin redemption instruction from the Customer system endpoint 710 to the Fiat Coin Issuer system 716. At step 731, the Issuer receives the redemption request and then transmits the instruction including data elements over a network to a Blockchain Node including Smart Contract public address. The Blockchain Node System then receives the redemption instruction message and transmits a Fiat Coin redemption instruction over a network to other Blockchain Node Systems. These Blockchain Node Systems receive the Fiat Coin redemption message and process it in accordance with blockchain computation methodology (e.g. Ethereum Virtual Machine). The Blockchain Node Systems also execute a Smart Contract computation to process the instruction in accordance with the blockchain Smart Contract methodology. The instructions include the amount of Fiat Coin to redeem, the public address to redeem from, and the burn address to send the Fiat Coin to.

Next, the Blockchain Node Systems record the Fiat Coin redemption transaction to a blockchain database in accordance with mining/consensus methodology (e.g. proof-of-work, proof-of-stake). At step 732, the Blockchain Node Systems transfers the coin from the Issuer public address to the burn public address by decreasing the balance(s) of the redeeming public address including the issuer public address(es) and then, at step 734, increasing the balance at the burn public address.

At step 736, the Issuer 716 then verifies the balance and updates their internal ledger balance with regard to the transaction. In one embodiment, the Issuer system transmits a burn validation query over a network to the Blockchain Node. The Blockchain Node then inspects the public address burn account balance on the blockchain in the Blockchain Database and transmits a burn account balance query response over a network to Issuer system. The Issuer system receives the account balance query response and records it in a transaction database. The Issuer system may also present the balance query response on a user interface.

The Issuer system 616 then validates that the customer has sufficient fiat currency funds to withdraw. For example, the Issuer system may query an account balance stored in an account database. The issuer system may then update its transaction database to reflect a withdrawal record and may update Customer account records stored in an account database to reflect account balance updates.

Next, at step 742, the issuer system reduces the Customer account balance account database record by withdrawal amount to reflect the coin redemption. At step 744, the issuer system issues a transfer request to transfer fiat from Issuer account at Custodial Bank 714 to the Customer account at Customer Bank 712. The Issuer transmits the transfer request, with data elements, over a network to a system at the Custodial Bank.

At step 746, the Custodial Bank system 714 receives the transfer request and then validates and processes the transfer instructions and the data elements of transaction. In one embodiment, the custodial bank system updates the Issuer account records stored in an account database to reflect account balance updates. The update may include recording an inbound transfer in a transaction database and decreasing an Issuer account balance in account database record by the transfer amount, as shown at step 748.

The Custodial Bank system 714 may then issue a transfer request to the Customer's bank system 712. The request may be transmitted, with data elements, over a network to system at Customer Bank. In another embodiment, the Customer Bank may transmit a request to a Central Bank (e.g. the U.S. Federal Reserve) in accordance with existing standard commercial and central bank fiat currency transfer processes.

Next, at step 750, the Customer Bank system 712 receives the transfer request and validates and processes the transfer instructions and data elements of the transaction. The customer bank may update the Customer account records stored in an account database to reflect the account balance updates. Additionally, the customer bank may record the inbound transfer in a transaction database. Next, at step 752, the customer bank may increase the Customer account balance in its account database record by the transfer amount.

Next, at step 754, the Customer verifies the updated balance of redeemed fiat currency at the Customer Bank using the customer endpoint system (e.g. mobile applications, PC, server). In one embodiment, the customer endpoint system transmits an account balance query over a network to Customer Bank. The Customer Bank system then inspects the Customer account balance in an account database and transmits am account balance query response with an account balance response over a network to the customer endpoint system.

At step 756, the Customer endpoint system receives the account balance query response and presents balance data to the Customer, for example by using a database and/or a user interface.

One embodiment of the present distributed ledger management system for interest bearing digitized currencies allows customers to transfer Fiat Coins using the blockchain. In one embodiment, the Customer may transfer a Fiat Coin to make a payment, including but not limited to in e.g. commerce, service of a loan, taxes, to pay for goods and services, etc. In another embodiment, a Customer may transfer Fiat Coin to settle a trade. In another embodiment, a Customer may transfer Fiat Coin to pledge it as collateral. In another embodiment, a Customer may transfer Fiat Coin to make a loan. In another embodiment, a Customer may transfer Fiat Coin to stake in an e.g. proof-of-stake consensus mechanism. In another embodiment, a Customer may transfer Fiat Coin to a custodian for safe keeping. In another embodiment, a Customer may transfer Fiat Coin to a burn address as part of a redemption. In another embodiment, a Customer may transfer Fiat Coin for a remittance. In another embodiment, a Customer may transfer Fiat Coin for a donation. In another embodiment, a Customer may transfer Fiat Coin for a gift. In another embodiment, a Customer may transfer Fiat Coin into an escrow for any escrow purpose.

In operation, to transfer Fiat Coin, the Customer may submit a Fiat Coin transfer instruction from the Customer's system endpoint. The system endpoint (e.g. mobile applications, PC, server) then transmits the instruction including data elements over a network to a Blockchain Node including a Smart Contract public address. The Blockchain Node System receives transfer instruction message and transmits a Fiat Coin transfer instruction over a network to Blockchain Node Systems.

The Blockchain Node Systems receive the Fiat Coin transfer message and process it in accordance with blockchain computation methodology (e.g. Ethereum Virtual Machine). In one embodiment the Blockchain Node Systems may execute Smart Contract computation to process the instruction in accordance with blockchain Smart Contract methodology. The instructions may include the amount of Fiat Coin to transfer, the public address to transfer from, and the public address to send Fiat Coin to.

The Smart Contract may also confirm that the target address is located in database known as a whitelist and only allow transfers if the target address appears in the whitelist. The Smart Contract may query the whitelist for account on blockchain whitelist database and the whitelist may be associated with the transferring account. The blockchain whitelist database may contain account identification data elements such as blockchain public address, country of origin, tax withholding requirements, etc. When the proposed transfer address is absent from the whitelist, the smart contract may terminate the transfer request. The smart contract may also send a notification to the Customer system endpoint.

The smart contract may then also query a restricted list database for additional regulatory checks. The restricted list database may contain account identification data elements such as blockchain public address, country of origin, known names, known addresses, countries and/or other identification attributes that may be identified as being prohibited from activity by a government body or for the Issuer. When any of the address data elements from white list are found to match elements found in the restricted list, the smart contract may terminate the transfer request and send notification to the Customer system endpoint.

The smart contract may also calculate the tax withholding requirement where applicable. Using tax data from the whitelist query, the smart contract may calculate the amount of the requested transfer to withhold for taxes. The smart contract may record the withholding amount in a database for tracking.

The smart contract may then update the requested transfer amount to be processed and confirm that the sender address has sufficient Fiat Coins to cover the requested transfer and any associated fees. If so, the smart contract may proceed to record the Fiat Coin transfer transaction(s) to the blockchain database in accordance with mining/consensus methodology (e.g. proof-of-work, proof-of-stake). Additionally, where applicable, the smart contract may process the tax withholding amount, for example by decreasing the amount of Fiat Coin to be sent to the public address(es) and instead sending the withheld amount of Fiat Coin to an Issuer public address(es) in order to increase an Issuer designated withholding public address balance.

The smart contract may then, where applicable, the process post-withholding balance. This may include decreasing the public address balance(s) of the sender including Customer address(es) and Issuer address(es) and increasing the public address balance of the receiver.

In one embodiment, the customer may then verify the updated balance of transferred Fiat Coins on blockchain using endpoint system. In operation, the endpoint system may transmit an account balance query over a network to Blockchain Node. The Blockchain Node may then inspect the public address account balance on the blockchain in the Blockchain Database and transmit an account balance query response over a network to Customer endpoint system. The Customer endpoint system may receive the account balance query response and presents the balance data to Customer, for example using a database and/or a user interface.

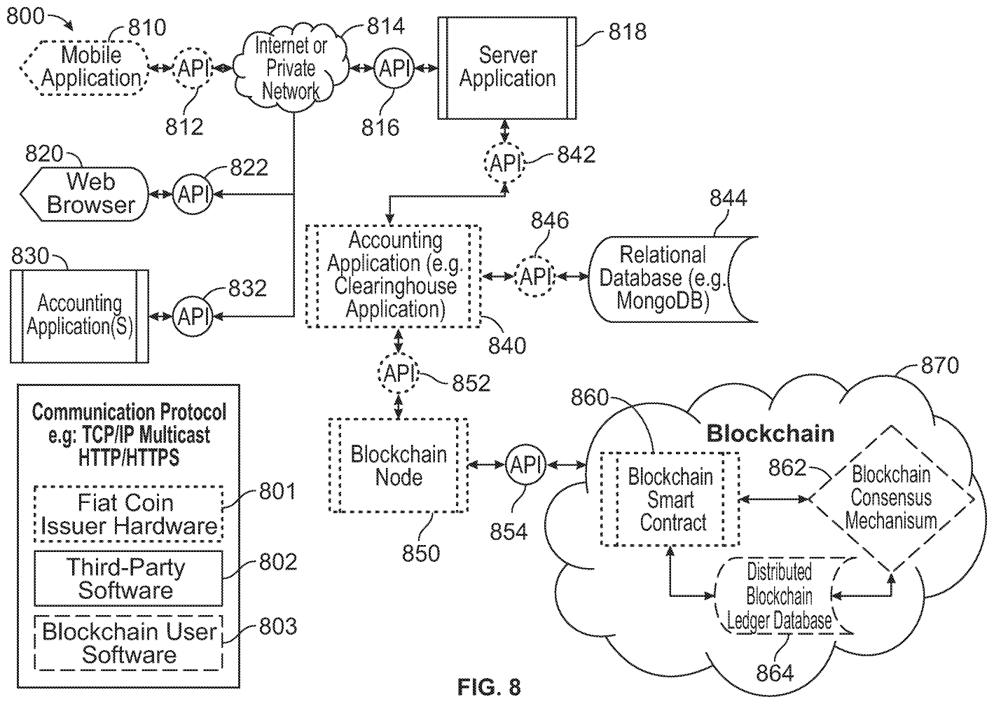

FIG. 8 illustrates an embodiment of the Fiat Coin Application Layer 800 according to an embodiment of the distributed ledger management system. As shown in FIG. 8, the components of the application layer 800 are illustrated in different line weightings to indicate Fiat Coin Issuer Software 801, Third-Party Software 802 and Blockchain User software 803.

As shown in FIG. 8, a mobile application may utilize an application programming interface 812 to send and receive data through the Internet or Private Network 814, to a server application 818 through the server application's application programming interface 816. Additionally, a web browser 820 may also utilize an application programming interface 822 to send and receive data through the Internet or Private Network 814, to a server application 818 through the server application's application programming interface 816. Further, one or more accounting applications 830 may also utilize an application programming interface 832 to send and receive data through the Internet or Private Network 814, to a server application 818 through the server application's application programming interface 816.

The server application 818 may then communicate through an application programming interface 842 with an accounting application 840, for example a clearinghouse application. The clearinghouse application 840 may also communicate with a relational database 844 such as MongoDB through an application programming interface 846.

Additionally, the accounting application 840 may communicate with a Blockchain Node 850 through the application programming interface 852. The Blockchain Node 850 may communicate with a Blockchain Smart Contract 860 resident on the Blockchain 870 through application programming interface 854.

Further, the Blockchain Smart Contract 860 may communicate with the Blockchain consensus mechanism 862 and distributed Blockchain ledger database 864 that are also resident on the Blockchain 870.

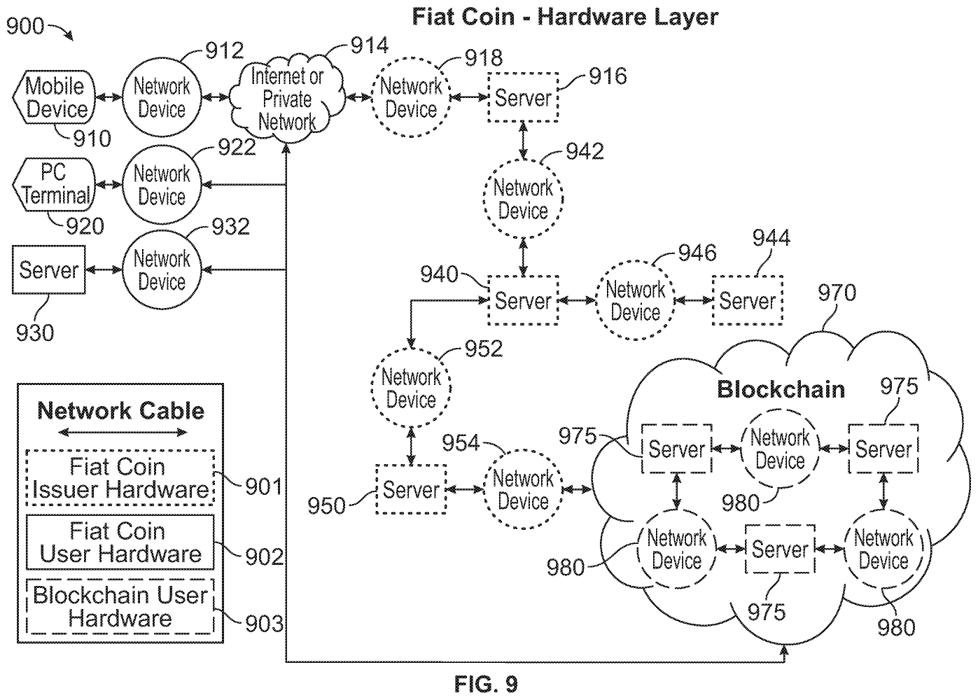

FIG. 9 illustrates an embodiment of the Fiat Coin Hardware Layer 900 according to an embodiment of the distributed ledger management system. As shown in FIG. 9, the components of the hardware layer 900 are illustrated in different line weightings to indicate Fiat Coin Issuer Hardware 901, Fiat Coin User hardware 902, and Blockchain User Hardware 903.

As shown in FIG. 9, a mobile device 910 may utilize a network device 912 to send and receive data through the Internet or Private Network 914, to a server 916 through a network device 918. Additionally, a PC terminal 920 may utilize a network device 922 to send and receive data through the Internet or Private Network 914, to the server 916 through the network device 918. Further, a server 930 may utilize a network device 932 to send and receive data through the Internet or Private Network 914, to the server 916 through the network device 918.

The server 916 may then communicate through a network device 942 with a server 940, for example at clearinghouse. The server 940 may also communicate with a server 944 through a network device 946.

Additionally, the server 940 may communicate with a server 950 through the network device 952. The server 850 may also communicate with the Blockchain 870 through any of the multiple servers 970 and/or network devices 980.

In one embodiment, FIG. 9 may be an overlay for FIG. 8. For example, the APIs of FIG. 8 may be implemented in the hardware of the network devices of FIG. 9. Additionally, the servers shown in FIG. 9 may implement the applications shown in FIG. 8 for their respective positions in the process.

Illustrative Smart Contract Function Descriptions

Below please find embodiments of Smart Contract Function Calls that may be used in one or more embodiments of the present invention.

Regulator Service

onlyOwner: These functions may only be accessed by the owner of the contract.
setPermission: Sets permission for the individual users of the system. This permission may vary by Fiat Coin, and may be turned off at any time.
setDate: Updates the current date for use later in interest logic. Calling this function triggers the distribution.

onlyEventContract: These functions may only be accessed by the Event Contract.
getParticipants: Takes a given coin as an input and returns a dictionary with the addresses of the registered users and their permissions.
getInterest: Takes period and interest payment as an input and returns the number of coins to be issued as interest on the given period.

onlyFiatcoin: This function may only be accessed by Fiat coin Contract.
check: Takes the addresses of the person sending coins and the person receiving coins and returns a tuple. The first element is a boolean, returning true if both the addresses are permissioned users, and false if one or both of them is not permissioned. The second element is the date that the transaction took place (set by setDate).

distribution Contract—does the computation of people and interest

onlyRegulatorService: These functions may only be called by the Regulator Service.
distribution: Four parts. Takes date as an input.

1. Gets number of coins to issue as interest from the Regulator Service for the previous period (getInterest).

2. Gets list of participants for the coin and their individual permissions (getParticipants).

3. For every permissioned user, returns their balance that is eligible for an distribution from the previous period (getdistributionBalance).

4. Mints the interest coins into the public addresses of the eligible users as a function of their eligible distribution balance from the previous period (mint).

Fiat coin(s)—the whole state is just storing how much money you have

hasMintPermission: This function may only be accessed by contracts that have mint permission. In this case it is the event contract and the owner of the contract.
mint: Takes an address and a number of coins as an input and adds this additional number of coins to the account.

onlyEventContract: This function may only be accessed by the Event Contract.
getdistributionBalance: Takes an address and a date and returns the balance that is eligible for a distribution and the address that the interest is directed to. This value is already saved in the contract. For calculation specifics, see transfer.

public: These functions may be accessed by anyone.
transfer: This function has two tasks.

1. Executes a transfer of assets, making sure that both of the counterparties are permissioned users of the Fiat Coin and that the sender has enough coins. If it is not a permissioned transaction, the funds do not transfer. When the check executed, a date is returned from the Regulator Service.

2. Updates each of the public address's distribution eligible balances. An example of how this works is as follows: the contract saves the lowest balance that the coin owner held over the course of the day. Every transaction, it checks to see if the coin owner is lower than its previous minimum for the day, and if so it updates the distribution eligible balance to the new value. If the address does not make any transactions in a given day, it is issued interest on its entire balance. This function is able to take the date into account because it is logged and returned by the Regulator Service.
burn: Allows the user to burn coins that they would like to cash out for Fiat in the bank. This function takes a coin quantity and decreases the senders balance by the specified amount. It then emits a signal that may be seen by the contract owner, notifying the burn amount and the address. From there the contract owner would be able to check the corresponding bank account and issue transfer orders.
shiftInterestAddress: Takes an address as an input and shifts the interest receiving address of the sender to the new address.

private (public?): This function may only be accessed by the contract itself.
check: This function takes both of the addresses and executes the check function from the Regulator Service to determine if the transaction is permissioned and on what date the transaction occurred.

Controller

setPermission: Sets permissions on a Fiat Coin for a given user.

setInterest: Sets total amount of interest to be issued on a given period.

Mint: Mints specific number of coins for an individual user.

Customer

transfer: Allows the user to transfer Fiat coins from one whitelisted address to another.

burn: Burns user coins that are to be redeemed at the bank for fiat currency. This deletes the specified number of coins and emits a message to the controller notifying them of the completion.

shiftInterestAddress: Allows the user to switch the address that their interest is issued to. This may be changed at any time

check (?): Allows the user to check whether or not a transaction will go through before it is sent over the network.

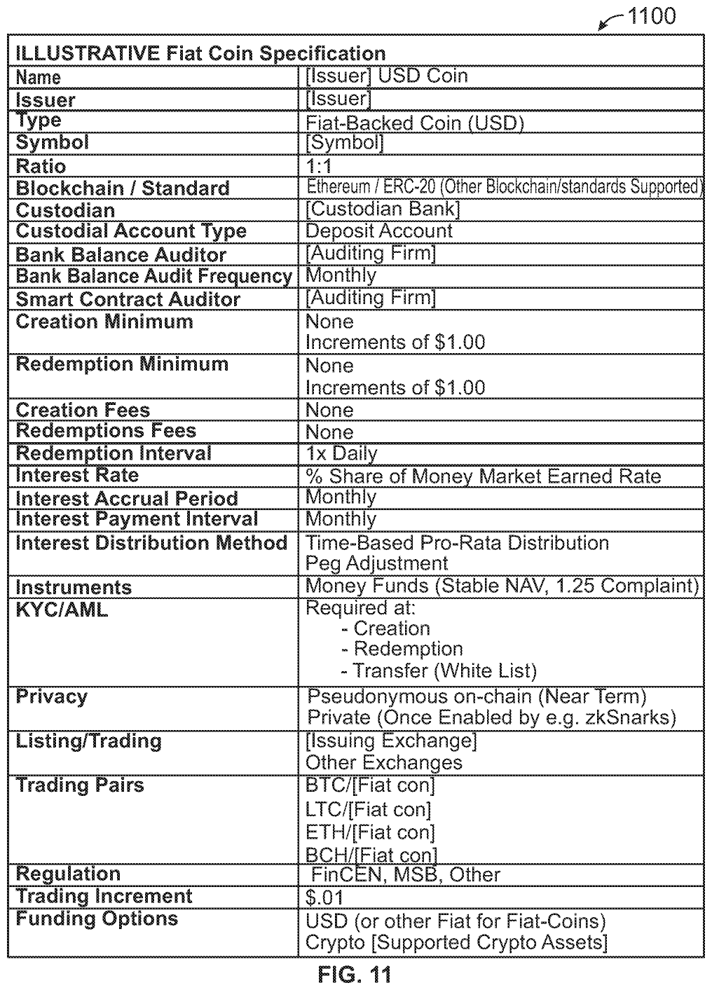

FIG. 11 illustrates an embodiment of a Fiat Coin data structure in accordance with the present invention.

### Definitions

Custodian: The entity where fiat currency deposits are held.

Issuer: Entity that issues the fiat coins.

Smart Contract: Application that manages the creation/redemption of fiat coins.

Node: Application that provides (e.g., offchain) inputs to the smart contract to calculate and distribute interest (e.g. in the form of new coins, adjustments to the peg ratio)

Multi-signature or Multisig: A configuration or design characteristic (e.g. of a Smart Contract) that requires multiple signatories to authorize a transaction (e.g. broadcasting a balance transfer to a blockchain network).

Burn: To destroy Fiat Coin(s) when redeeming them for fiat currency.

As shown in FIG. 11, the embodiment of the Fiat Coin 1100 includes the following data elements:

Name: representing the name of the specific Fiat Coin, such as “USD Coin”

Issuer: representing the name or other identifier of the issuer of the Fiat

Coin.

Type: representing the type of Fiat Coin, wherein the types include Fiat-backed coin (USD).

Symbol: representing a trading symbol for this Fiat Coin.

Ratio: representing the ratio of Fiat Coins to the underlying Fiat Currency.

Blockchain/Standard: representing the blockchain and blockchain standard on which the Fiat coin will operate, for example, Ethereum/ERC-20 (other blockchain/standards supported).

Custodian: representing the name of the custodian bank for the Fiat Coin.

Custodial Account Type: representing the type of custodial account at the custodial bank, such as a Deposit Account, for example.

Bank Balance Auditor: representing the name of the auditing firm that will audit the bank balance.

Bank Balance Audit Frequency: representing the frequency at which the Fiat Coin bank balance will be audited, for example, Monthly.

Smart Contract Auditor: representing the name of the auditing firm that will audit the smart contract.

Creation Minimum: representing the minimum value of Fiat Coin that may be created, for example, there may be no minimum and/or an increment minimum of $1.00 USD.

Redemption Minimum: representing the minimum value of Fiat Coin that may be redeemed, for example, there may be no minimum and/or an increment minimum of $1.00 USD.

Creation Fees: representing the fee for creating the Fiat Coin, for example, “None” or a fixed dollar amount.

Redemptions Fees: representing the fee for redeeming the Fiat Coin, for example, “None” or a fixed dollar amount.

Redemption Interval: representing the time intervals at which the Fiat Coin may be redeemed, for example 1 time per Day.

Interest Rate: representing the percentage share of money market earned rate.

Interest Accrual Period: representing the frequency at which interest will accrue, for example, Monthly.

Interest Payment Interval: representing the frequency at which interest will be paid, for example, Monthly.

Interest Distribution Method: representing the method under which interest will be distributed, for example, Time-based pro-rata distribution or a Peg Adjustment.

Instruments: representing the underlying instrument for which interest will be received, for example, Money Funds (Stable NAV, 1.25 compliant).

KYC/AML: representing Know-Your-Customer/Anti-Money Laundering information. Tis information may be required at Creation, Redemption, and/or Transfer (white list).

Privacy: representing the privacy setting for the Fiat Coin, for example, Pseudonymous on-chain (near term) or Private (once enabled by e.g. zkSnarks).

Listing/Trading: representing an identification of the issuing exchange for the Fiat Coin and/or other exchanges.

Trading Pairs: representing the cryptocurrencies for which the Fiat Coin may be traded, for example, BTC/[fiat coin], LTC/[fiat coin], ETH/[fiat coin], and BCH/[fiat coin]

Regulation: representing the regulatory body overseeing the Fiat Coin, for example, FinCEN, MSB, or another/

Trading Increment: representing the increment in which the Fiat Coin may be priced for trading, for example, $.01

Funding Options: representing the funding sources that may be used to purchase the Fiat Coin, for example, USD (or other fiat for fiat-coins) and/or supported crypto assets, such as Bitcoin.

Table 1 illustrates several commercial use cases for the Fiat Coin

TABLE 1

| | Commercial Opportunity/Utility |
|---|---|
| [fiat coin]/* | On-chain DvP |
| spot pairs trading | Convenience of seamlessly moving |
| | on/off chain |
| [fiat coin]/* | Convenience of seamlessly moving |
| futures trading | on/off chain |
| [fiat coin] | On-chain USD value transfer |
| payments/value transfer | |
| [fiat coin] | On-chain USD collateral |
| collateral | |
| [fiat coin] | Quickly and easily transfer USD between |
| treasury management | exchanges to settle trades |

As shown in Table 1, the Fiat Coin may be used in spot pairs trading, which may provide the opportunity for on-chain delivery versus payment as well as the convenience of seamlessly moving on and off the blockchain.

Additionally, the Fiat Coin may be used in futures trading, which may provide the convenience of seamlessly moving on and off the blockchain.

The Fiat Coin may also be used to make payments and/or for value transfer. This provides the utility of an on-chain USD collateral.

Finally, the Fiat Coin may be used for treasury management because it provides the utility of being able to quickly and easily transfer USD between exchanges to settle trades.

Some functional aspects for one or more embodiments of the Fiat Coin include the following components:

1. Regulatory & Banking: Fiat currencies supported determined by relevant regulatory approvals and/or Issuer custodial accounts denominated in target currency

2. Systems & System Endpoints: Software application(s) including locally installed desktop applications, mobile applications, web-based applications, Hardware including server(s), computer(s), or mobile device(s), Databases including in memory, relational, and Networks including public and private networks, which may include fiber optic, copper, microwave networks

3. Communication Protocols: for example, ACH, Fedwire, SWIFT, FIX, and others.

4. Data Elements: for example, Currency, Value, Source account (including Account Name, Account Number, and Account Balance), Destination account (including Routing Number and Account Number), Transfer date, Transfer time, Public address, Private address, Cryptographic signature, Interest rate, Interest balance, Interest allocation, Conversion ratio, Coin balance, and White list indicator.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A blockchain-based, distributed ledger management system for interest bearing digital coins, said system including:
a custodial bank system receiving an electronic deposit of fiat currency from a customer, wherein said deposit of fiat currency is placed in an account that is entitled to a periodic interest payment;
a fiat coin issuer system, wherein in response to said deposit of fiat currency, said fiat coin issuer system activates a blockchain-based smart contract to create fiat coin,
wherein the number of said fiat coin created is in proportion to the dollar value of said fiat currency,
wherein said fiat coin is distributed to the public address of said customer on said blockchain; and
a blockchain node system executing a smart contract to calculate and credit interest to said public address of said customer, wherein said smart contract receives an interest amount based on said deposit of fiat currency and generates additional fiat coin in proportion to the dollar value of said interest amount, wherein said additional fiat coin is distributed to the public address of said customer on said blockchain.

2. The system of claim 1 wherein said customer may electronically opt-in to receive said additional fiat coins.

3. The system of claim 1 wherein said customer may electronically opt-out to the receipt of said additional fiat coins.

4. The system of claim 1 wherein, when said periodic interest payment is negative, said smart contract triggers a forced burn of fiat coin proportion to the value of the negative interest rate payment.

5. The system of claim 1, wherein in response to a redemption request from said customer, said fiat coin issuer system activates a blockchain based smart contract that burns fiat coin proportional in value to said redemption request.

6. The system of claim 5 wherein said fiat coin issuer system then causes a bank account of said customer to be credited with said fiat currency in a value reflected by said redemption request.

7. A blockchain-based, distributed ledger management system for interest bearing digital coins, said system including:
a custodial bank system receiving an electronic deposit of fiat currency from a customer, wherein said deposit of fiat currency is placed in an account that is entitled to a periodic interest payment;
a fiat coin issuer system, wherein in response to said deposit of fiat currency, said fiat coin issuer system activates a blockchain-based smart contract to create fiat coin,
wherein the number of said fiat coin created is in proportion to the dollar value of said fiat currency,
wherein said fiat coin is distributed to the public address of said customer on said blockchain; and
a blockchain node system executing a smart contract to calculate and credit interest payable due to said periodic interest payment, wherein said smart contract alters the redemption value of said fiat coin relative to said dollar value of said fiat currency to reflect said periodic interest payment.

8. The system of claim 7 wherein said customer may electronically opt-in to receive said additional fiat coins.

9. The system of claim 7 wherein said customer may electronically opt-out to the receipt of said additional fiat coins.

10. The system of claim 7 wherein, when said periodic interest payment is negative, said smart contract adjusts said redemption value of said fiat coin relative to said dollar value of said fiat currency to increase the amount of fiat coin required proportional to said negative interest rate payment.

11. The system of claim 7, wherein in response to a redemption request from said customer, said fiat coin issuer system activates a blockchain based smart contract that burns fiat coin proportional in value to said redemption request.

12. The system of claim 11 wherein said fiat coin issuer system then causes a bank account of said customer to be credited with said fiat currency in a value reflected by said redemption request.
